(19) United States
(12) Patent Application Publication
(10) Pub. No.: US 2026/0113411 A1
(43) Pub. Date: Apr. 23, 2026

(54) INKJET PRINTING APPARATUS, PRINTING METHOD THEREOF, AND IMAGE PROCESSING APPARATUS

(71) Applicant: CANON KABUSHIKI KAISHA, Tokyo (JP)

(72) Inventor: TATSUO SHIMMOTO, Tokyo (JP)

(21) Appl. No.: 19/363,786

(22) Filed: Oct. 21, 2025

(30) Foreign Application Priority Data
Oct. 23, 2024 (JP) 2024-186892

(51) Int. Cl. H04N 1/60; B41J 2/21; G06K 15/10

(52) U.S. Cl. CPC H04N 1/6022; B41J 2/2103; B41J 2/2117; G06K 15/102

(57) ABSTRACT

An inkjet printing apparatus comprises: a first printing unit that prints a specific color image by applying a specific color ink having a specific color on a printing medium; a second printing unit that prints a color image by applying a color ink onto the specific color image printed on the printing medium; and a control unit that controls an application amount of the specific color ink by the first printing unit. The control unit determines an application amount per unit area of the specific color ink in accordance with a viewing condition in a case where an observer views a printing medium on which the color image is printed.

### CROSS-REFERENCE TO PRIORITY APPLICATION

This application claims the benefit of Japanese Patent Application No. 2024-186892, filed Oct. 23, 2024, which is hereby incorporated by reference herein in its entirety.

### BACKGROUND

### Field of the Technology

The present disclosure relates to a technique for forming an image by applying ink.

### Description of the Related Art

There is a known inkjet printing apparatus that prints an image on a printing medium by ejecting ink from a print head and applying the ink to the printing medium. A transparent printing medium may be used for window advertisement display use. When an image is printed on a transparent printing medium, stack printing of a color ink layer and a white ink layer may be performed in order to adjust the transparency (degree of transmittance) of the color ink layer.

However, since it is difficult to quantify the transparency, the print clients and the print shops actually perform printing work and check whether the transparency is as expected. As a result of the actual checking, in a case where the transparency is not as expected, the white ink application amount (white hiding ratio) is adjusted and the printing work is performed again. Japanese Patent Laid-Open No. 2019-147267 (Patent Document 1) discloses a method of adjusting an ejection ratio indicating an amount per unit area of white ink in accordance with a hiding ratio of a color image.

However, in a print product obtained by printing by the method disclosed in Patent Document 1, there is a case where preferable color development is not obtained depending on a viewing condition.

### SUMMARY

The present disclosure provides a technique that can suppress a decrease in color development depending on a viewing condition.

An inkjet printing apparatus comprises: a first printing unit that prints a specific color image by applying a specific color ink having a specific color on a printing medium; a second printing unit that prints a color image by applying a color ink onto the specific color image printed on the printing medium; and a control unit that controls an application amount of the specific color ink by the first printing unit, wherein the control unit determines an application amount per unit area of the specific color ink in accordance with a viewing condition in a case where an observer views a printing medium on which the color image is printed.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a perspective view of an inkjet printing apparatus.

FIG. 2 is a cross-sectional view of a printing apparatus.

FIG. 3 is a schematic diagram describing a print head.

FIG. 4 is a view illustrating a print control system.

FIG. 5 is a flowchart of print data generation.

FIG. 6 is a view describing an image formation process of stack image printing.

FIGS. 7A-7C are views describing stack image printing.

FIG. 8 is a view describing a relationship between a viewing condition and a white hiding ratio with respect to color development.

FIG. 9 is a view describing a relationship between a viewing condition and a white hiding ratio with respect to a color reproduction region.

FIG. 10 is a view describing three viewing conditions.

FIG. 11 is a flowchart of image data processing (first embodiment).

FIG. 12 is a schematic diagram illustrating a color reproduction region as a solid.

FIG. 13 is a view describing application amount adjustment of ink in accordance with a viewing condition (first embodiment).

FIGS. 14A and 14B are views illustrating an example of an LUT in accordance with a viewing condition (first embodiment).

FIGS. 15A-15C are views illustrating distribution processing of a color ink, a W ink, and a reaction liquid ink.

FIG. 16 is a view describing application amount adjustment of ink in accordance with a viewing condition (second embodiment).

FIGS. 17A and 17B are views illustrating an example of an LUT in accordance with a viewing condition (second embodiment).

FIG. 18 is a view illustrating a color reproduction region in which an adjustment method of the white hiding ratio is varied in accordance with a hue angle.

FIG. 19 is a view illustrating an example of a UI screen for printing mode selection.

FIG. 20 is a view illustrating an example of a UI screen that enables the white ink application amount to be manually adjusted.

### DESCRIPTION OF THE EMBODIMENTS

Hereafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

As a first embodiment of an inkjet printing apparatus according to the present disclosure, a serial type inkjet printing apparatus will be described below as an example. In the following, first, multipass stack image printing in the printing apparatus will be described, and then adjustment of a white hiding ratio in accordance with a viewing condition will be described.

### Apparatus Configuration

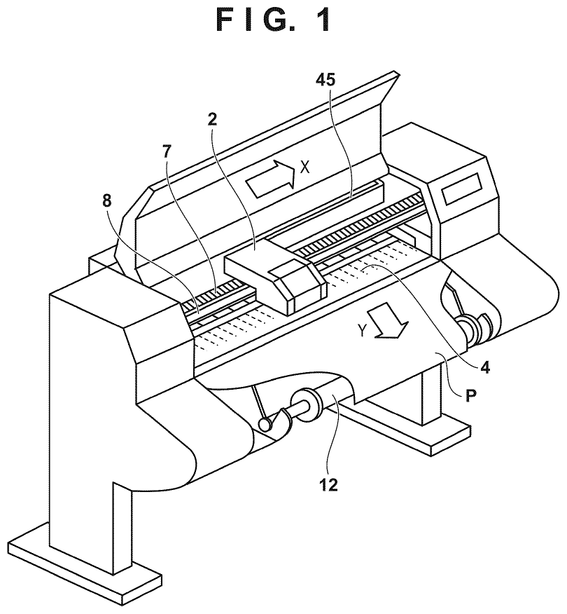

FIG. 1 is an external perspective view of the inkjet printing apparatus (printer). This is what is called a serial type printer that prints an image (ink image) on a printing medium P by scanning a print head in a cross direction (X direction) orthogonal to a conveyance direction (Y direction) of the printing medium P.

An outline of the configuration of this inkjet printing apparatus and the operation at the time of printing will be described. First, the printing medium P is conveyed in the Y direction by a winding spool 12 holding the printing medium P by a conveyance roller driven by a conveyance motor not illustrated via a gear. On the other hand, at a predetermined conveyance position, a carriage motor not illustrated causes a carriage unit 2 to reciprocally scan (reciprocally move) along a guide shaft 8 extending in the X direction.

Then, in the process of this scanning, an ejection operation is performed from an ejection orifice (nozzle) of the print head detachably mounted to the carriage unit 2 at a timing based on a position signal obtained by an encoder 7, and a constant bandwidth corresponding to an array range of the ejection orifice is printed. The present embodiment is configured to perform scanning at a scanning speed of 40 inches per second, and perform a printing operation at a resolution of 1200 dpi ( 1/1200 inch interval). Thereafter, it is configured to convey the printing medium P, and perform printing for the next bandwidth.

Note that a carriage belt can be used to transmit a driving force from the carriage motor to the carriage unit 2. However, in place of the carriage belt, it is also possible to use another driving method such as one including a lead screw rotationally driven by the carriage motor, for example, and extending in the X direction and an engagement portion provided at the carriage unit 2 and engaged with a groove of the lead screw.

The printing medium P having been fed is nipped and conveyed by a paper feed roller and a pinch roller, and is guided to a printing position (scanning region of the print head) on a platen 4. Since capping is performed on a face surface of the print head in a normal pause state, a cap is opened prior to printing to bring the print head or the carriage unit 2 into a scannable state. Thereafter, when data for one scan is accumulated in a buffer, the carriage unit 2 is scanned by the carriage motor to perform printing.

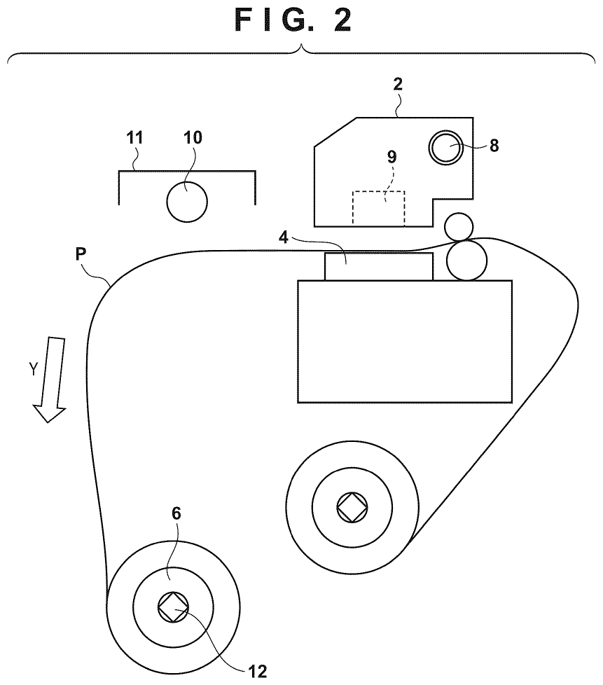

FIG. 2 is a cross-sectional view of the printing apparatus. A print head 9 attached to the carriage unit 2 reciprocally scans in a main scanning direction X at the position of the platen 4. A heater 10 supported by a frame not illustrated is arranged in a curing region positioned downstream of the position of the platen 4 in a sub-scanning direction Y. The heater 10 dries liquid ink on the printing medium P by heat. The heater 10 is covered with a heater cover 11, and the heater cover 11 has a function of efficiently irradiating the printing medium P with the heat of the heater 10 and a function of protecting the heater 10.

After being printed by the print head 9, the printing medium P is wound by a winding spool 12 and forms a winding medium 6 having a roll shape. Specific examples of the heater 10 include a sheathed heater and a halogen heater. The heating temperature of a heating unit in the curing region is set in consideration of the filming property and productivity of a water-soluble resin emulsion and the heat resistance of the printing medium P. Note that as a heating means of the heating unit in the curing region, hot air blowing heating from above, contact type heat conduction type heater heating from below the printing medium P, or the like may be used. The heating means of the heating unit in the curing region is provided at one place in the present form, but may be provided at two or more places and used in combination.

There may be a separate in-printing drying heater (not illustrated) for drying liquid ink in the middle of printing on the printing medium P at the position of the platen 4 where the print head 9 reciprocally scans in the main scanning direction X. The heating temperature of the heating unit in the region of the platen 4 is lower than the heating temperature of the heating unit in the curing region, and is set in consideration of ink drying and fixing on a nozzle surface of the print head 9 and productivity. Note that as a heating means of the heating unit in the region of the platen 4, hot air blowing heating from above, non-contact type heat radiation type heater heating from above, or the like may be used.

Here, the printing apparatus of the present form can perform what is called multipass printing of printing an image with respect to a predetermined region (1/n band) on the printing medium P by a plurality of (n) scans of the print head 9. This multipass printing will be described in detail later.

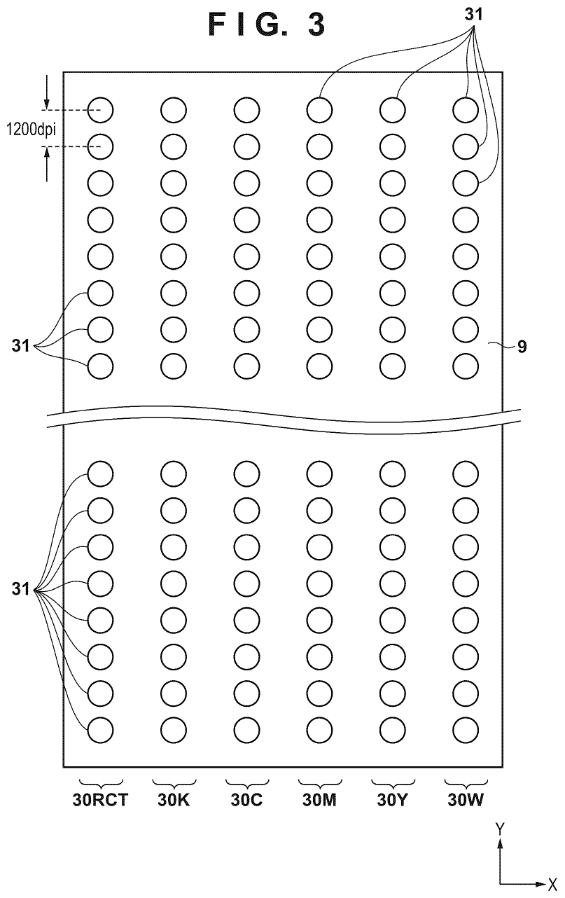

FIG. 3 is a schematic diagram describing the print head 9. The print head 9 includes an ejection orifice row 30K that ejects a black ink (K), an ejection orifice row 30C that ejects a cyan ink (C), and an ejection orifice row 30Y that ejects a magenta ink (M) and a yellow ink (Y) as ink containing a color material. Since each of the black ink (K), the cyan ink (C), the magenta ink (M), and the yellow ink (Y) contains a color material, these inks are also referred to as a color ink for the sake of simplicity in the following description.

As a specific color ink having a specific color, in the present form, a white ink containing a white pigment for improving color development on the printing medium P is used, and an ejection orifice row 30W that ejects a white ink (W) is included.

The print head 9 includes an ejection orifice row 30RCT that ejects a reaction liquid ink (RCT) not containing a color material. This reaction liquid ink does not contain a color material, but contains a reactant agent that reacts with the color material contained in the color ink, and can reduce bleeding by coming into contact with the color ink on the printing medium P. This reaction liquid ink may react with a white pigment (titanium oxide) contained in the white ink, or may react with a water-soluble resin emulsion contained in the white ink. Alternatively, a second reaction liquid ink dedicated to white ink may be separately prepared separately from the reaction liquid ink (RCT) for color ink, and the print head 9 may include an ejection orifice row (not illustrated) that ejects the second reaction liquid ink.

Note that in the present form, four types of color inks (K, C, M, and Y) are included as a color ink, but the present disclosure is not limited to this, and a light cyan ink (Lc) or a light magenta ink (Lm) may be included as a light ink. As a color ink, a gray ink (GY) may be included as a new light ink, and a green ink (G), an orange ink (OR), a red ink (R), and a blue ink (B), which are special color inks, may be included. In the present form, the white ink (W) is included as a specific color ink, but the present disclosure is not limited to this, and a metallic ink containing metal particles that applies metallic luster may be included.

In the print head 9, these ejection orifice rows are arranged side by side in the order of the ejection orifice rows 30RCT, 30K, 30C, 30M, 30Y, and 30W from the left side to the right side in the X direction. These ejection orifice rows 30RCT, 30K, 30C, 30M, 30Y, and 30W are configured by arraying 1280 ejection orifices 31 that eject respective inks in the Y direction (conveyance direction) at a density of 1200 dpi. Note that in the present form, the ejection amount of ink ejected at one time from one ejection orifice 31 is about 6 pl.

Each of these ejection orifice rows 30RCT, 30K, 30C, 30M, 30Y, and 30W is connected to an ink tank (not illustrated) that stores corresponding ink, and ink is supplied. Note that the print head 9 and the ink tank used in the present form may be integrally configured, or may be configured to be separable from each other. A detailed ink composition of each of the black ink (K), the cyan ink (C), the magenta ink (M), the yellow ink (Y), the reaction liquid ink (RCT), and the white ink (W) will be described later.

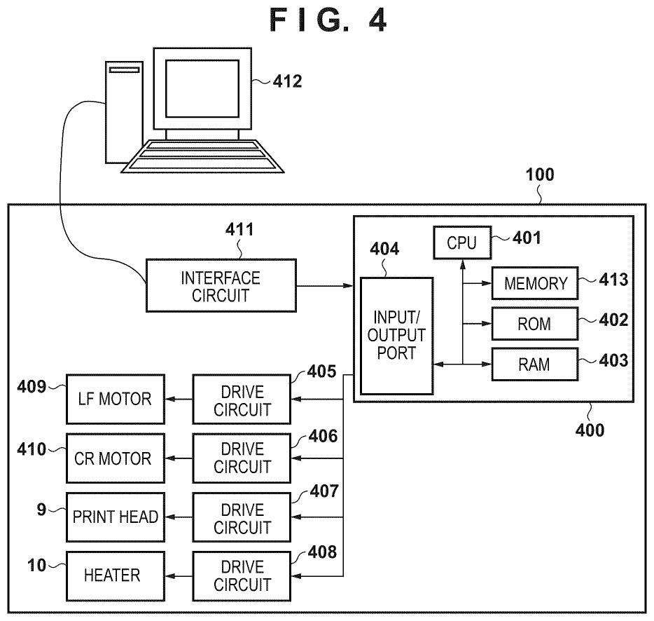

FIG. 4 is a view illustrating a print control system in a printing apparatus 100. A main control unit 400 includes a CPU 401 that executes various processing operations, a ROM 402 that stores a control program and the like to be executed by the CPU 401, a RAM 403 used as a buffer of print data, and an input/output port 404. A memory 413 stores a mask pattern and the like described later. A conveyance motor (LF motor) 409, a carriage motor (CR motor) 410, the print head 9, a heater 25, and drive circuits 405, 406, 407, and 408 such as an actuator in a cutting unit are connected to the input/output port 404. Furthermore, the main control unit 400 is connected to a host PC 412 via an interface circuit 411.

### Print Data Generation Operation

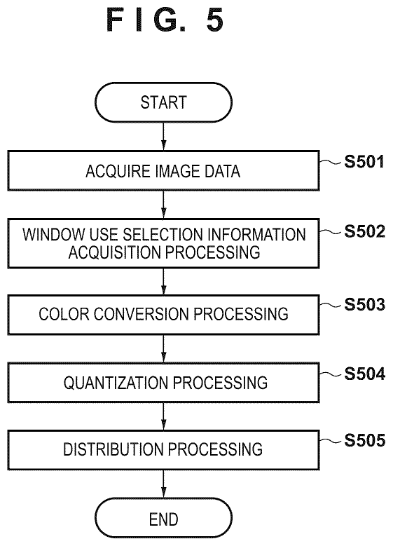

FIG. 5 is a flowchart of print data generation. The present flowchart is implemented by the CPU 401 executing a control program.

In S501, the CPU 401 acquires image data (luminance data) represented by 8-bit, 256-value information (0 to 255) for each color of red (R), green (G), and blue (B) input from the PC 412, which is a host computer, to the printing apparatus 100.

In S502, the CPU 401 acquires window use selection information. The window use selection information is information indicating that a print product is arranged/displayed on a transparent window. In S503, the CPU 401 converts the image data represented by R, G, and B into multi-value data represented by a plurality of types of inks (K, C, M, Y, RCT, and W) used for printing. This color conversion processing generates multi-value data represented by the 8-bit, 256-value information (0 to 255) that determines gradation of each ink of K, C, M, Y, RCT, and W in each pixel group including a plurality of pixels.

In S504, quantization of multi-value data represented by K, C, M, Y, RCT, and W is executed. The quantization generates quantization data (binary data) represented by 1-bit, 2-value information (0, 1) determining ejection or non-ejection of each ink of K, C, M, Y, RCT, and W with respect to each pixel. Note that as the quantization processing, the processing can be performed in accordance with various quantization methods such as an error diffusion method, a dither method, and an index method.

In S504, distribution processing of distributing the quantization data to a plurality of scans with respect to a predetermined region of the print head 9 is performed. This distribution processing generates print data represented by 1-bit, 2-value information (0, 1) determining ejection or non-ejection of each ink of K, C, M, Y, RCT, and W with respect to each pixel in each of the plurality of scans with respect to the predetermined region of the printing medium P. This distribution processing is executed using a mask pattern that corresponds to the plurality of scans and determines permission or non-permission of ink ejection for each pixel.

In the present form, ejection of the ink from the print head 9 is performed in accordance with the print data generated as described above. Note that a form in which the CPU 401 in the printing apparatus 100 executes the entire processing of S501 to S505 has been described here, but implementation by another form is possible. For example, a form in which the PC 412 executes the entire processing of S501 to S505 may be adopted. For example, a form in which the PC 412 executes part of the processing, and the printing apparatus 100 executes the remaining.

One image data is acquired in S501, and converted into multi-value data represented by K, C, M, Y, RCT, and W in S503, but the present disclosure is not limited to this. For example, in S501, two image data of color image data and white image data may be acquired.

The present form is described on an assumption that the image data acquired in S501 is RGB data, but CMYK data (luminance data) represented by cyan (C), magenta (M), yellow (Y), and black (K) may be acquired. The CMYK data is, for example, a raster image obtained by interpreting image data represented by a page description language by a raster image processor (RIP).

### Multipass Stack Image Printing

In the present form, an image is printed by what is called multipass printing in which printing is performed with a plurality of scans with respect to a predetermined region on the printing medium P using each ink of K, C, M, Y, RCT, and W. Here, general multipass stack image printing will be described below, in which a white ink layer is printed first on the printing medium P and stack image printing of a color ink layer is performed later on the white ink layer.

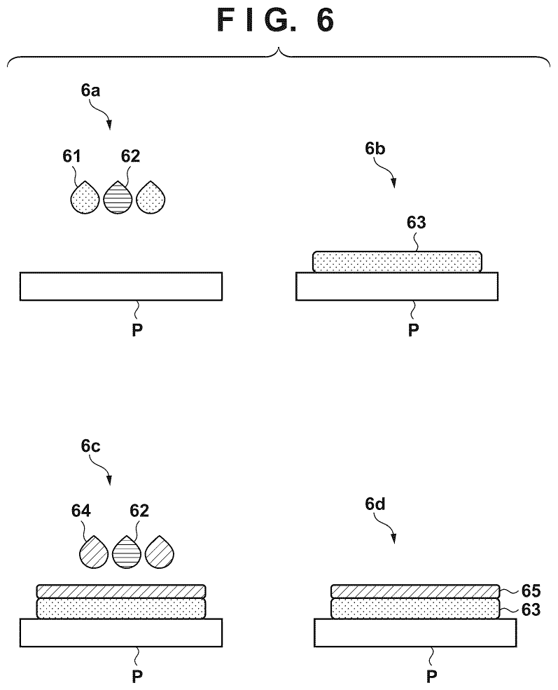

FIG. 6 is a view describing an image formation process of multipass stack image printing. First, a W ink 61 and an RCT ink 62 are ejected on the printing medium P (process 6a), and a white ink layer 63 (specific color image) is formed (process 6b). On this white ink layer 63 (i.e., on the specific color image), a color ink 64 (K, C, M, and Y) and the RCT ink 62 are ejected later (process 6c), and a color ink layer 65 (color image) is formed (process 6d). All of these processes are performed in the region of the platen 4 of FIG. 2, and then a stack image of the white ink layer 63 and the color ink layer 65 is filmed by heat in the curing region positioned downstream in the sub-scanning direction Y.

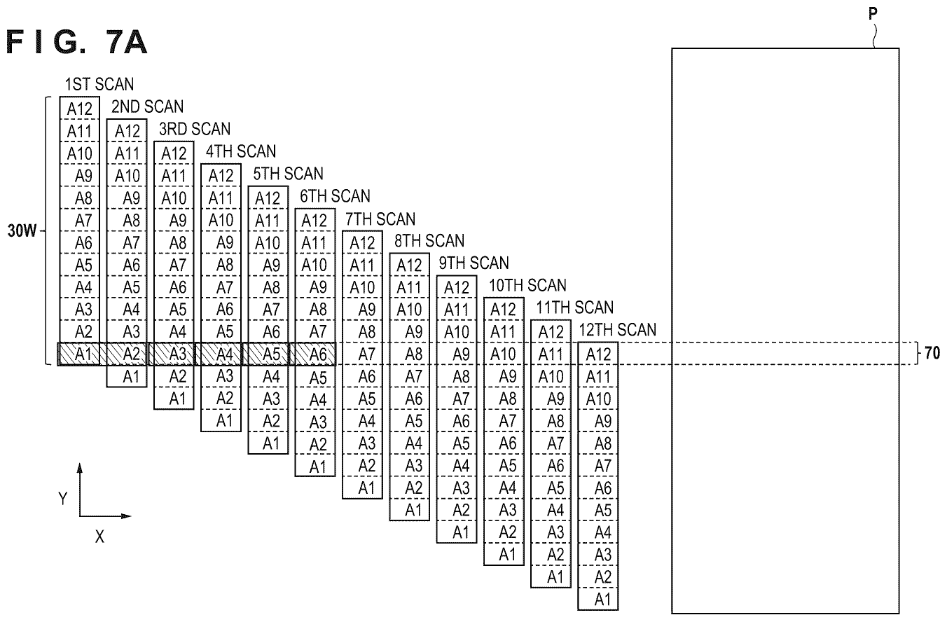

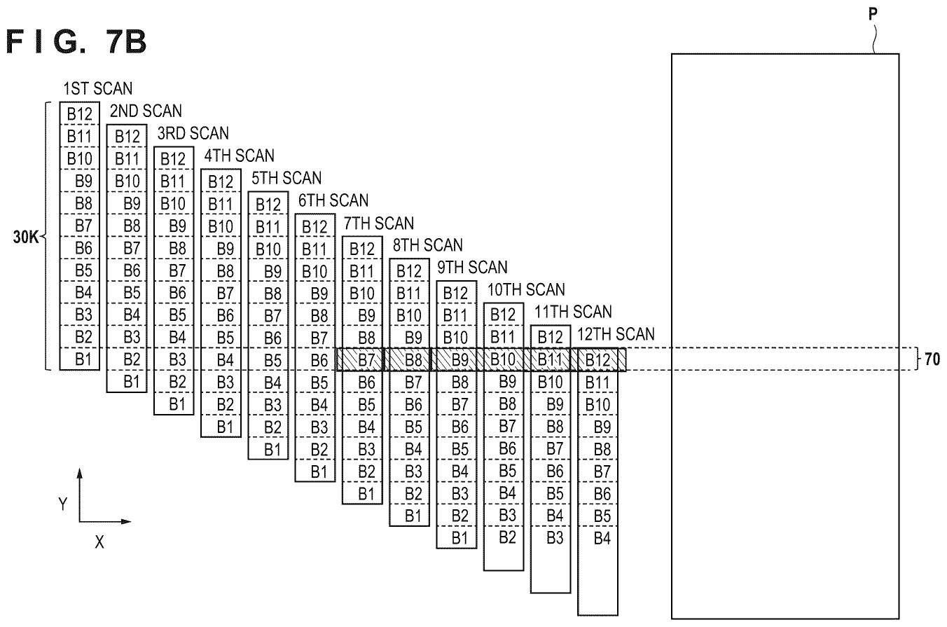

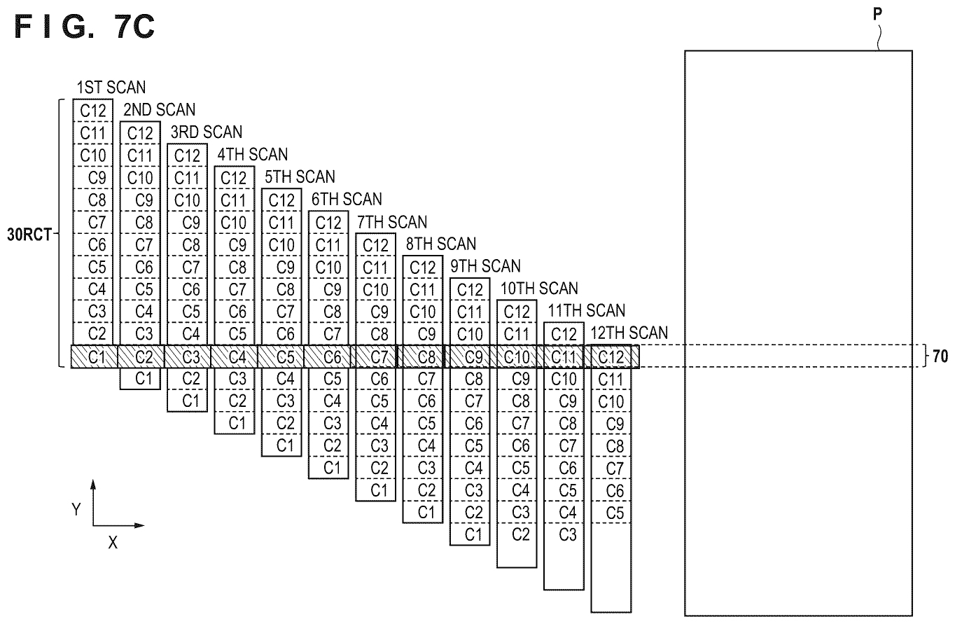

FIGS. 7A-7C are views for describing multipass stack image printing. The printing apparatus of the present form can perform what is called multipass stack image printing in which, with respect to a predetermined region (1/n band) on the printing medium P by a plurality of (n) scans of the print head 9, a white image (specific color image) is printed first and a color image is printed later thereon.

Here, let n=12, and, with respect to the predetermined region on the printing medium P, the white image is first printed in the first six passes, that is, the first to sixth scans, and stack image printing of the color image is performed later thereon in the second six passes, that is, the seventh to twelfth scans.

First, the W ink is printed in the first six passes (first to sixth scans) (FIG. 7A). The W ink is ejected in each of the six scans with respect to the predetermined region from each of six ejection orifice groups A1 to A6 of twelve ejection orifice groups A1 to A12 configured by dividing the ejection orifice row 30W illustrated in FIG. 7A into twelve in the Y direction (conveyance direction). On the other hand, the W ink is not ejected in each of the six scans with respect to the predetermined region from the six ejection orifice groups A7 to A12 of the ejection orifice row 30W. Note that in practice, the printing medium Pis conveyed downstream in the Y direction between the scans of the print head 9, but in FIGS. 7A-7C, for the purpose of simplifying the description, the print head 9 is moved upstream in the Y direction between the scans.

In the scan of the first time (first scan), the print head 9 is scanned in a positional relationship in which a predetermined region 70 on the printing medium P and the ejection orifice group A1 in the ejection orifice row 30W face each other. At this time, the ejection orifice group A1 is ejected to the predetermined region 70 in accordance with the print data corresponding to the W ink corresponding to the first scan. After this first scan ends, the printing medium P is conveyed by a distance corresponding to one ejection orifice group in the Y direction. Thereafter, the scan of the second time (second scan) is performed, and the ejection orifice group A2 is ejected to the predetermined region 70. Thereafter, the conveyance of the printing medium P and the ejection from the print head 9 are alternately performed, and the ejection from the ejection orifice groups A3 to A6 in the third to sixth scans with respect to the predetermined region 70 is executed. In this manner, the multipass printing of the W ink with respect to the predetermined region 70 is completed.

Next, in the second six passes (seventh to twelfth scans), color inks (K, C, M, and Y inks) are printed (FIG. 7B). For the purpose of simplifying the description, the K ink will be described below as a representative. The K ink is ejected in each of the six scans with respect to the predetermined region from each of six ejection orifice groups B7 to B12 of twelve ejection orifice groups B1 to B12 configured by dividing the ejection orifice row 30K illustrated in FIG. 7B into twelve in the Y direction (conveyance direction). On the other hand, the K ink is not ejected in each of the six scans with respect to the predetermined region from each of the six ejection orifice groups B1 to B6 of the ejection orifice row 30K.

In the scan of the seventh time (seventh scan), the print head 9 is scanned in a positional relationship in which the predetermined region 70 on the printing medium P and the ejection orifice group B7 in the ejection orifice row 30K face each other. At this time, the ejection orifice group B7 is ejected to the predetermined region 70 in accordance with the print data corresponding to the K ink corresponding to the seventh scan. After this seventh scan ends, the printing medium P is conveyed by a distance corresponding to one ejection orifice group in the Y direction. Thereafter, the scan of the eighth time (eighth scan) is performed, and the ejection orifice group B8 is ejected to the predetermined region 70.

Thereafter, the conveyance of the printing medium P and the ejection from the print head 9 are alternately performed, and the ejection from the ejection orifice groups B9 to B12 in the ninth to twelfth scans with respect to the predetermined region 70 is executed. In this manner, multi-pass stack image printing of the K ink is completed later on the previously printed W ink layer with respect to the predetermined region 70. Similarly to the case of the K ink illustrated in FIG. 7B, also for the C, M, and Y inks, multi-pass stack image printing of the C, M, and Y inks is completed later on the previously printed W ink layer with respect to the predetermined region 70.

For the RCT ink, the RCT ink is printed in 12 passes, that is, up to the first to twelfth scans (FIG. 7C). Therefore, the RCT ink is ejected in each of twelve scans with respect to the predetermined region from each of twelve ejection orifice groups C1 to C12 configured by dividing the ejection orifice row 30RCT illustrated in FIG. 7C into twelve in the Y direction (conveyance direction).

In the scan of the first time (first scan), the print head 9 is scanned in a positional relationship in which a predetermined region 70 on the printing medium P and the ejection orifice group C1 in the ejection orifice row 30RCT face each other. At this time, the ejection orifice group C1 is ejected to the predetermined region 70 in accordance with the print data corresponding to the RCT ink corresponding to the first scan. After this first scan ends, the printing medium P is conveyed by a distance corresponding to one ejection orifice group in the Y direction. Thereafter, the scan of the second time (second scan) is performed, and the ejection orifice group C2 is ejected to the predetermined region 70.

Thereafter, the conveyance of the printing medium P and the ejection from the print head 9 are alternately performed, and the ejection from the ejection orifice groups C3 to C12 in the third to twelfth scans with respect to the predetermined region 70 is executed. In this manner, the multipass printing of the RCT ink with respect to the predetermined region 70 is completed, and the RCT ink can be applied to the W ink in the first “six passes” and the color ink in the second “six passes”.

Note that here, with respect to a predetermined region, a view of scanning the print head 9 twelve times in total to print an image has been drawn, but the present disclosure is not limited to this, an image may be printed with the number of scans larger than twelve times, and the predetermined region in this case is narrower in the Y direction than the predetermined region 70. An image may be printed with the number of scans less than twelve times, and the predetermined region in this case is wider in the Y direction than the predetermined region 70. Here, a case where the number of printing passes of the white image and the number of printing passes of the color image are the same “six passes” of the twelve scans has been described, but the present disclosure is not limited to this, and the number of passes of the white image and the number of passes of the color image may be different.

In the above description, a case has been described, in which a white image is printed first with respect to a predetermined region on the printing medium P, and stack image printing of a color image is performed later thereon. However, a color image may be printed first with respect to a predetermined region on the printing medium P, stack image printing of a white image may be performed later thereon, and the stack order of the color image and the white image may be different. Furthermore, the number of stacks may be other than two layers, and may be three layers (stack order of a color image, a white image, and a color image) or five layers (a color image, a white image, a black image, a white image, and a color image).

### Details of Ink

Details of each ink constituting an ink set used in the present form will be described. Hereinafter, “part” and “%” are based on mass unless otherwise specified.

### 1. Ink Composition

Here, the composition of each ink will be described in detail. The color inks (K, C, M, and Y inks) used in the present form contain color material pigments other than white. As the color material, black-based, cyan-based, magenta-based, and yellow-based color material pigments are used. As described later, these color material pigments are prepared as a dispersion solution in an aqueous solution, then mixed with other predetermined material components, and ink is adjusted.

The white ink (W) of the present form contains a white color material as a color material. As the white color material of the white ink, titanium oxide particles can be preferably used. Titanium oxide has a rutile type, an anatase type, and a brookite type in terms of its crystal structure. Among them, titanium oxide is preferably the rutile type having low photocatalytic activity. Examples of a production method of titanium oxide include a sulfate method and a chlorine method. The content (mass %) of titanium oxide particles in the ink is preferably 5 mass % or more and 20 mass % or less based on the total mass of the ink from the viewpoint of ink stability.

The zeta potential of titanium oxide particles in pure water is preferably 0 mV or more. The zeta potential is an index indicating the charged state of the titanium oxide particle surface, and can be measured by an electrophoretic light scattering method. When a positive charge amount is larger than a negative charge amount on the titanium oxide particle surface, the titanium oxide particles are easily adsorbed to a resin having an anionic group, and the dispersion stability of titanium oxide is improved. The zeta potential is preferably 40 mV or less in order to avoid an insufficient charge repulsive force between titanium oxide particles due to excessive consumption of the anionic group of the resin.

As the white color material of the white ink, other than titanium oxide particles, resin particles having a hollow structure can be used in combination. Examples of the resin particles having a hollow structure include resin particles containing units derived from styrene and acrylic such as MH5055 (manufactured by Zeon Corporation), ROPAQUE OP-62, OP-84J, OP-91, HP-1055, HP-91, and ULTRA (manufactured by Rohm and Haas); and resin particles containing units derived from crosslinked styrene and acrylic such as SX-863(A), 864(B), 866(A), 866(B), and 868 (manufactured by JSR Corporation), ROPAQUE ULTRA E and ULTRA DUAL (manufactured by Rohm and Haas).

Note that the white ink contains the above-described white color material as a main component, but in order to adjust a slight white tint visually recognized by reflected light or the like, it is also possible to contain other color materials within a range in which the whiteness is not impaired.

The color inks (K, C, M, and Y), the reaction liquid ink (RCT), and the white ink (W) used in the present form all contain a water-soluble organic solvent. The water-soluble organic solvent preferably has a boiling point of 150° C. or more and 300° C. or less for the reason wettability and moisturization of the face surface of the print head 9. From the viewpoint of the function of the film-forming agent with respect to the resin particles and swelling solubility to the printing medium on which a resin layer is formed, ketone compounds such as acetone and cyclohexanone, ethylene glycol derivatives such as tetraethylene glycol dimethyl ether, heterocyclic compounds having a lactam structure represented by N-methyl-pyrrolidone and 2-pyrrolidone, and the like are particularly preferable. From the viewpoint of ejection performance, the content of the water-soluble organic solvent is preferably 3 wt. % or more and 30 wt. % or less. Specific examples of the water-soluble organic solvent include alkyl alcohols having 1 to 4 carbon numbers such as methyl alcohol, ethyl alcohol, n-propyl alcohol, isopropyl alcohol, n-butyl alcohol, sec-butyl alcohol, and tert-butyl alcohol. Amides such as dimethylformamide and dimethylacetamide. Ketones or ketoalcohols such as acetone and diacetone alcohol. Ethers such as tetrahydrofuran and dioxane. Polyalkylene glycols such as polyethylene glycol and polypropylene glycol. Alkylene glycols in which an alkylene group contains 2 to 6 carbon atoms, such as ethylene glycol, propylene glycol, butylene glycol, triethylene glycol, 1,2,6-hexanetriol, thiodiglycol, hexylene glycol, and diethylene glycol. Lower alkyl ether acetate such as polyethylene glycol monomethyl ether acetate. Glycerin. Lower alkyl ethers of polyhydric alcohol such as ethylene glycol monomethyl (or ethyl) ether, diethylene glycol methyl (or ethyl) ether, and triethylene glycol monomethyl (or ethyl) ether. Polyhydric alcohol such as trimethylol propane and trimethylol ethane. N-methyl-2-pyrrolidone, 2-pyrrolidone, 1,3-dimethyl-2-imidazolidinone, and the like.

The above-described water-soluble organic solvent can be used alone or as a mixture. It is desirable to use deionized water as water. Note that the content of the water-soluble organic solvent in the reaction liquid (RCT) is not particularly limited. However, in addition to the above-described components, an antifoaming agent, a preservative, an anti-mold agent, and the like can be appropriately added to the color inks (K, C, M, and Y) and the white ink (W) in order to have desired physical properties as necessary.

The color inks (K, C, M, and Y), the reaction liquid (RCT), and the white ink (W) used in the present form all contain a surfactant. The surfactant is used for the purpose of improving the wettability and spreadability of the ink with respect to the printing medium. The larger the addition amount of the surfactant is, the stronger the property of reducing the surface tension of the ink, and the wettability and spreadability of the ink with respect to the printing medium are improved. In the present form, a small amount of acetylene glycol EO adduct or the like was added as a surfactant, and the static surface tension of each ink was adjusted to 30×10⁻³ N/m or less, and the difference in static surface tension between color inks was adjusted to 2×10⁻³ N/m or less. More specifically, all color inks had a static surface tension of approximately 22 to 24×10⁻³ N/m. For measurement of the static surface tension of the ink, a fully automatic surface tensiometer CBVP-Z (manufactured by Kyowa Interface Science Co., Ltd.) was used. Note that the measuring instrument is not limited to that exemplified above as long as the static surface tension of the ink can be measured.

The pH of each color ink of the present form is stable on the alkali side, and the value thereof is 8.5 to 9.5. The pH of each color ink is preferably 7.0 or more and 10.0 or less from the viewpoint of preventing elution or deterioration of a member in contact with each color ink in the printing apparatus or the print head, a decrease in solubility of a dispersion resin in the color ink, and the like. The pH was measured using pH METER model F-52 manufactured by HORIBA, Ltd. Note that the measuring instrument is not limited to that exemplified above as long as the pH of the ink can be measured.

### 2. Water-Soluble Resin Emulsion

The color inks (K, C, M, and Y) and the white ink (W) used in the present form contain a water-soluble resin emulsion.

In the present form, the “water-soluble resin emulsion” means polymer fine particles existing in a state of being dispersed in water. Specific examples of the water-soluble resin emulsion include acrylic resin fine particles synthesized by emulsion polymerization or the like of monomers such as (meth)acrylic acid alkyl ester or (meth)acrylic acid alkyl amide; styrene-acrylic resin fine particles synthesized by emulsion polymerization or the like of monomers such as (meth)acrylic acid alkyl ester or (meth)acrylic acid alkyl amide and styrene; and polyethylene resin fine particles, polypropylene resin fine particles, polyurethane resin fine particles, and styrene-butadiene resin fine particles. Specific examples may include core shell type resin fine particles having different polymer compositions in a core portion and a shell portion constituting the resin fine particles, or resin fine particles obtained by emulsion polymerization in a periphery of acrylic fine particles synthesized in advance for controlling the particle diameter as seed particles. Furthermore, specific examples may include hybrid resin fine particles in which different resin fine particles such as acrylic resin fine particles and urethane resin fine particles are chemically bonded.

### 3. Slip Agent

The color ink and the white ink used in the present form contain a slip agent.

In the present form, the “slip agent” means wax particles or silicone oil. Specific examples of the wax particles include synthetic wax particles such as Fischer-Tropsch wax (EMUSTAR-6315) manufactured by Nippon Seiro Co., Ltd. and polyolefin wax (HITEC E-9500) manufactured by Toho Chemical Industry Co., Ltd., carnauba wax (Cellozol 524) manufactured by Chukyo Yushi Co., Ltd., and natural wax particles such as paraffin wax (AQUACER497) manufactured by BYK Japan K.K. The slip agent may be silicone oil, and examples thereof include polyether-modified silicone (BYK333) manufactured by BYK Japan K.K.

### 4. Reactant Agent

In order to solve image problems such as bleeding and beading, the present form adopts, as necessary, a system for printing using a reaction liquid ink for insolubilizing some or all of solid components of the color inks (K, C, M, and Y) and the white ink (W).

An object of the reactant agent of the reaction liquid ink is to insolubilize a dissolved dye and a dispersed pigment and resins. Therefore, examples of the reactant agent include polyvalent metal ions (e.g., magnesium sulfate, magnesium nitrate, magnesium chloride, emulsified calcium, aluminum sulfate, iron chloride, and the like). As one type of the aggregation action using such a cation, it is also possible to use a system using a cationic polymer aggregating agent having a low molecular weight for the purpose of charge neutralization of the water-soluble resin emulsion and insolubilization of an anionic soluble substance.

Examples of other reaction systems include an insolubilization system using a reaction liquid ink using a difference in pH. As described earlier, in general, color inks used for inkjet printing are often stable on the alkali side due to the property of the color material and the like. The pH is generally 7.0 or more and 10.0 or less, but is mainly set around 8.5 to 9.5 in many cases from an industrial point of view and in consideration of an influence of an external environment or the like. In order to aggregate and solidify the color ink of such a system, a stable state can be broken by mixing an acidic solution and fluctuating the pH, and the dispersed components can be aggregated. For the purpose of such an action, an acidic solution can also be used as the reaction liquid ink.

### Printing Medium

The printing apparatus in the present form performs printing onto the printing medium P having a low absorbency that is difficult to absorb moisture. As mentioned earlier, the printing medium P having a low absorbency mentioned here is a medium having no water absorbency or having an extremely small absorption amount thereof. Therefore, in the aqueous ink containing no organic solvent, the ink is repelled and image formation cannot be performed. On the other hand, it is excellent in water resistance and weather resistance, and is suitable as a medium for forming a print product for outdoor use. Normally, a printing medium having a water contact angle of 45° or more, preferably 60° or more at 25° C. is used.

The printing medium P in the present form is a transparent printing medium such as transparent PET or transparent vinyl chloride, and in the present disclosure, “transparent” indicates a property of having transparency with respect to visible light, and includes colorless and transparent and colored and transparent. Hereinafter, the printing medium P is assumed to be colorless and transparent unless otherwise specified.

The printing medium P having a low absorbency and being transparent is a printing medium in which a plastic layer is formed on the outermost surface of a base material, a printing medium in which an ink receptive layer is not formed on a base material, a sheet or a film of glass, plastic, or the like. Examples of the plastic coated as described above include polyvinyl chloride, polyethylene terephthalate (PET), nylon, biaxially oriented polypropylene (OPP), and unoriented polypropylene (CPP). Since these printing media P having a low absorbency and being transparent are excellent in water resistance, light resistance, and abrasion resistance, and are transparent printing media, they are generally used when printing print products for outdoor/indoor window advertisement display.

As an example of a method of evaluating the absorbency of the printing medium P, it is possible to use the Bristow method described in “Method for determining the liquid absorbability of paper and board (Bristow's method)” of J. TAPPI standard No. 51. In the Bristow method, a predetermined amount of ink is injected into a retaining container having an opening slit of a predetermined size, processed into a strip shape via the slit, and brought into contact with a printing medium wound around a disk. Thereafter, the disk is rotated while the position of the retaining container is fixed, and the area (length) of an ink band to be transferred to the printing medium is measured. The transfer amount (mLm⁻²) per unit area for 1 second can be calculated from the area of this ink band. In the present form, a printing medium in which the transfer amount (water absorption amount) of ink at 30 msec^{1/2} by the Bristow method described above is smaller than 10 mLm⁻² is regarded as the printing medium P having a low absorbency.

Adjustment of White Hiding Ratio in Accordance with Viewing Conditions

In the first embodiment, adjustment of the white hiding ratio in consideration of a viewing condition (ratio of reflected light illuminance and transmitted light illuminance) will be described. In particular, a method for enabling creation of a print product preferable for designated viewing conditions will be described.

First, the relationship between the viewing condition (ratio of reflected light illuminance and transmitted light illuminance) and the white hiding ratio with respect to color development will be described. Note that hereinafter, a reflection component of light irradiated from the observer side when the observer views the surface on which the color image of the product of stack image printing of the color ink layer/white ink layer is printed is called “reflected light”. A transmission component of light irradiated from the side opposite to the observer (i.e., the white image side) is called “transmitted light”. The illuminance is an amount of irradiation light per unit area.

Hereinafter, a case will be described, in which a print product on which stack image printing is performed in the order of the white ink layer 63 and then the color ink layer 65 on the printing medium P that is transparent is attached to a transparent window 803 (arranged on the window), and an observer 800 views from the color ink layer 65 side.

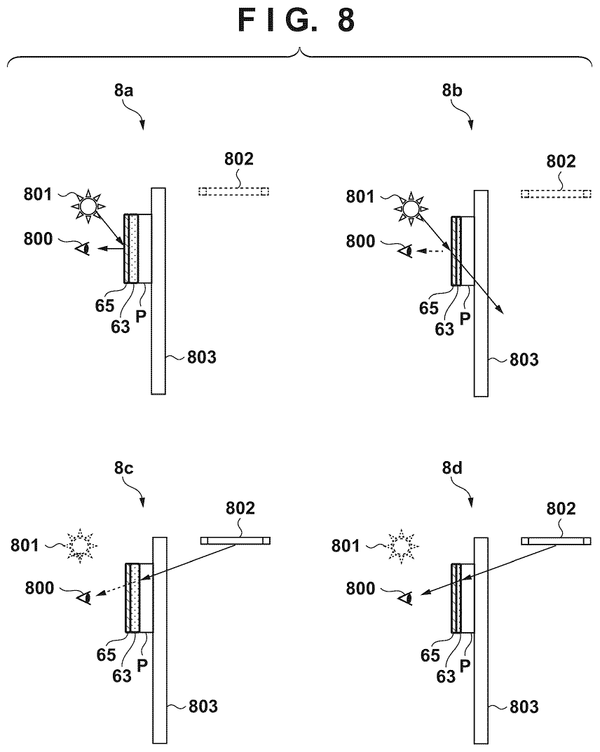

FIG. 8 is a view describing the relationship between the viewing condition (ratio of reflected light illuminance and transmitted light illuminance) and the white hiding ratio with respect to color development. Situations 8a and 8b are views illustrating a case where the viewing condition of the observer 800 is that the reflected light illuminance by sunlight 801 is the main, and the transmitted light illuminance by illumination light 802 behind the transparent window 803 is small. Situations 8c and 8d are views illustrating a case where the viewing condition of the observer 800 is that the reflected light illuminance by the sunlight 801 is small, and the transmitted light illuminance by the illumination light 802 behind the transparent window 803 is the main.

In the case where the viewing condition of the observer 800 is that the reflected light illuminance by the sunlight 801 is the main, and the transmitted light illuminance by the illumination light 802 behind the transparent window 803 is small, the white ink layer 63 is thick (white hiding ratio is high) as in the situation 8a. In this case, the sunlight 801 is reflected by the white ink layer 63, and the observer 800 sees a color image by receiving the reflected light. On the other hand, when the white ink layer 63 is thin (white hiding ratio is low) as in the situation 8b, the sunlight 801 is transmitted without being reflected by the white ink layer 63, and therefore it is difficult for the observer 800 to receive the reflected light and it is difficult to see the color image.

In the case where the viewing condition of the observer 800 is that the reflected light illuminance by the sunlight 801 is small, and the transmitted light illuminance by the illumination light 802 behind the transparent window 803 is the main, the white ink layer 63 is thick (white hiding ratio is high) as in the situation 8c. In this case, since the illumination light 802 is difficult to transmit through the white ink layer 63, it is difficult for the observer 800 to receive the transmitted light, and it is difficult to see the color image. On the other hand, when the white ink layer 63 is thin (white hiding ratio is low) as in the situation 8d, the illumination light 802 transmits through the white ink layer 63, and the observer 800 receives the transmitted light, whereby it is difficult to see the color image.

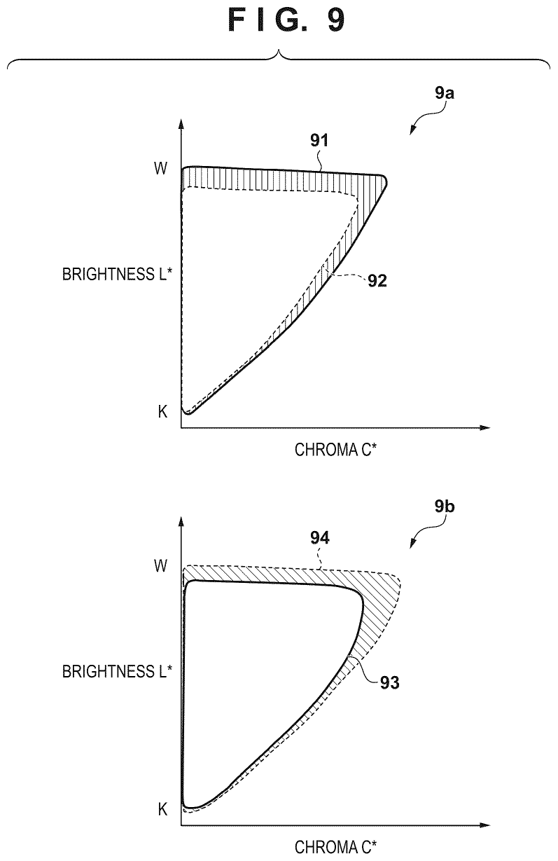

FIG. 9 is a view illustrating the relationship between the viewing condition (ratio of reflected light illuminance and transmitted light illuminance) and the white hiding ratio with respect to a color reproduction region. Here, a color reproduction region W-Y-K from a bright part to a dark part of a Y hue will be described. A graph 9a shows a color reproduction region in a case where the viewing condition is mainly reflected light illuminance, and a graph 9b shows a color reproduction region in a case where the viewing condition is mainly transmitted light illuminance. A bold line region 91 of the graph 9a is the color reproduction region W-Y-K in a case where the viewing condition is mainly the reflected light illuminance and the white hiding ratio is high. A dotted line region 92 of the graph 9a is the color reproduction region W-Y-K in a case where the viewing condition is mainly the reflected light illuminance and the white hiding ratio is low.

On the other hand, a bold line region 93 of the graph 9b is the color reproduction region W-Y-K in a case where the viewing condition is mainly the transmitted light illuminance and the white hiding ratio is high. A dotted line region 94 of the graph 9b is the color reproduction region W-Y-K in a case where the viewing condition is mainly the transmitted light illuminance and the white hiding ratio is low. Thus, in a case where the viewing condition is mainly the reflected light illuminance, the color image has high color development when the white hiding ratio is high, but the color image has low color development when the white hiding ratio is low. On the other hand, in a case where the viewing condition is mainly the transmitted light illuminance, the color image has low color development when the white hiding ratio is high, but the color image has high color development when the white hiding ratio is low.

Note that the “white hiding ratio” in the present form is a value that can be derived in accordance with, for example, ISO 23498 “Graphic technology—Visual opacity of printed white ink”.

### Viewing Conditions

In order to easily create a print product preferable for the viewing condition, it is necessary to consider adjustment of the white hiding ratio and the viewing condition (ratio of reflected light illuminance and transmitted light illuminance) of the observer. Here, as input values of the viewing condition, reflected light illuminance information and transmitted light illuminance information are acquired. The reflected light illuminance information is illuminance information of light irradiated from the observer side with respect to the color image of the product of stack image printing of the color ink layer/white ink layer. The transmitted light illuminance information is illuminance information of light irradiated from the side opposite to the observer (i.e., the white image side) with respect to the color image. Then, as one of the input values of the viewing condition (ratio of reflected light illuminance and transmitted light illuminance), for example, a transmitted light illuminance ratio (relative ratio of transmitted light illuminance to the sum of reflected light illuminance and transmitted light illuminance) is used.

When the ratio of ambient irradiation light (sunlight and illumination light) is calculated, illuminance (lux) representing the light amount per unit area, for example, may be used. In a normal display window, the illuminance of indoor illumination light is about 2000 lux. The brightness is about 50000 lux in direct sunlight. The brightness is about 10000 lux in the rain and about 500 lux in the evening.

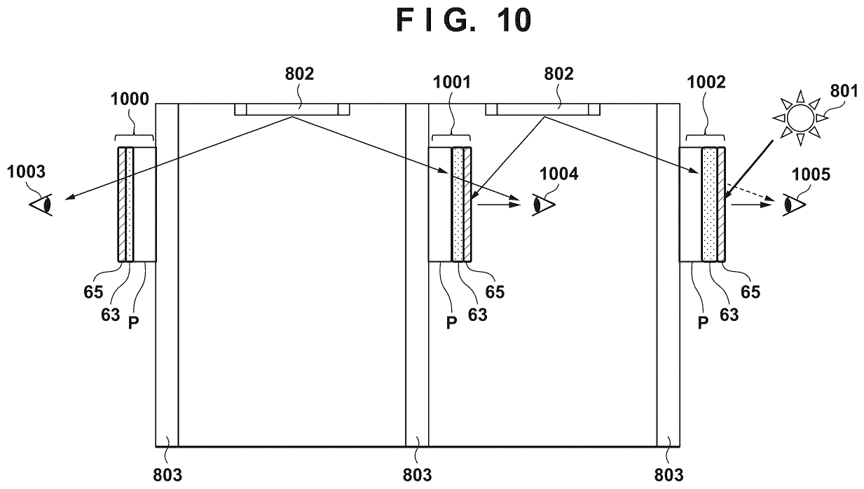

FIG. 10 is a view describing the viewing condition (ratio of reflected light illuminance and transmitted light illuminance). Here, various viewing conditions with different observation positions of the observer and times of day for the print products (color images on the printing medium) attached and displayed on three different windows 803 will be described. In a print product 1000 displayed on the outdoor side with respect to the window 803 facing the north, the reflected light illuminance such as sunlight or a street light is small with respect to an observer 1003, and transmitted light by the indoor illumination light 802 is the main. For example, assuming that the outdoor illuminance is 500 lux in the shade and the illuminance of the indoor illumination light 802 is 2000 lux, the viewing condition of the print product 1000 is a transmitted light illuminance ratio of 80% (=2000 lux/(500 lux+2000 lux)×100%).

It is assumed that a print product 1001 displayed on the indoor window 803 is installed at a position far from the window that is not affected by direct sunlight of the sunlight 801. In that case, with respect to an observer 1004, the reflected light illuminance by the indoor illumination light 802 on the observer side and the transmitted light by the indoor illumination light 802 on the back side of the window are about the same. For example, assuming that the illuminance of the indoor illumination light 802 is 2000 lux for both, the viewing condition of the print product 1001 is, for example, a transmitted light illuminance ratio of 50% (=2000 lux/(2000 lux+2000 lux)×100%).

On the other hand, in a print product 1002 displayed on the outdoor side with respect to the window 803 facing the south, the reflected light illuminance of the sunlight 801 is the main with respect to an observer 1005, and the transmitted light by the indoor illumination light 802 is small. For example, assuming that the indoor illumination light 802 is 2000 lux and the illuminance of the sunlight 801 is 50000 lux, the viewing condition of the print product 1002 is, for example, a transmitted light illuminance ratio of 4% (=2000 lux/(50000 lux+2000 lux)×100%).

However, the viewing condition of the print product 1002 also fluctuates depending on the time of day and the weather. For example, in a case where the time of day is not daytime but evening, the reflected light illuminance of the sunlight 801 is reduced with respect to the observer 1005. Assuming that the indoor illumination light 802 is 2000 lux and the illuminance of the sunlight 801 is 500 lux, the viewing condition of the print product 1002 is, for example, a transmitted light illuminance ratio of 80% (=2000 lux/(500 lux+2000 lux)×100%).

For example, in a case where the weather is not clear but rainy, the reflected light illuminance of the sunlight 801 is still large with respect to the observer 1005. For example, assuming that the indoor illumination light 802 is 2000 lux and the illuminance of the sunlight 801 is 10000 lux, the viewing condition of the print product 1002 is, for example, a transmitted light illuminance ratio of 17% (=2000 lux/(10000 lux+2000 lux)×100%). The print product 1002 displayed on the outdoor side with respect to this window 803 facing the south is not printed on the assumption of rain on purpose. Therefore, in practice, if the main window display time of day is a bright time of day, the viewing condition may be a transmitted light illuminance ratio of about 4%. If the main window display time of day is a dark time of day after the evening, the viewing condition may be the transmitted light illuminance ratio of 17% or more.

### Apparatus Operation

In the present embodiment, the white hiding ratio of the white image to be stacked and printed on the color image (i.e., application amount of the W ink) is adjusted. Specifically, the white hiding ratio is adjusted based on the presence or absence of the window use selection information and the viewing condition (ratio of reflected light illuminance and transmitted light illuminance).

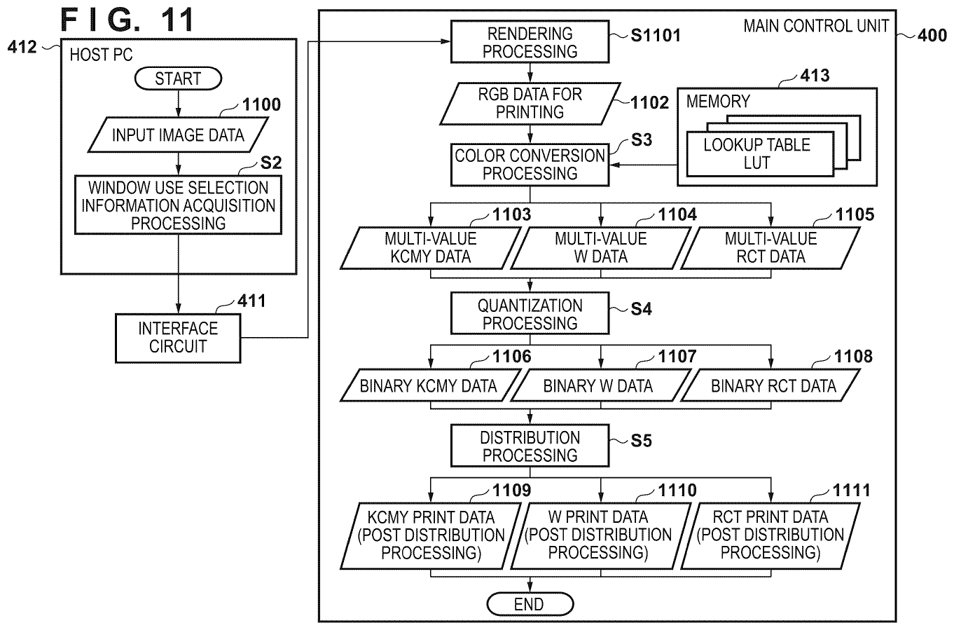

FIG. 11 is a flowchart of image data processing. Here, processing at the host PC 412 and the printing apparatus 100 constituting an image processing system is described separately. Note that in the present embodiment, the printing apparatus 100 including the main control unit 400 functions as an image processing apparatus that performs processing of determining the white hiding ratio based on the viewing condition, but the host PC 412 may function as the image processing apparatus described above. The host PC 412 installed with a printer driver performs acquisition processing (S502) of window use selection information with respect to input image data 1100. The main control unit 400 of the printing apparatus 100 performs image processing with respect to the input image data 1100 to be transferred from the host PC 412 via the interface circuit 411.

First, the main control unit 400 performs rendering processing on the input image data 1100 at a resolution of 1200 dpi (S1101). This generates printing multi-value RGB data 1102. In the present embodiment, it is assumed that the printing multi-value RGB data 1102 is data of 8-bit values (256 values).

In color conversion processing (S503), the multi-value printing RGB data 1102 is converted into KCMY data 1103, W data 1104, and RCT data 1105 based on a lookup table (LUT) stored in the memory 413. The KCMY data 1103, the W data 1104, and the RCT data 1105 are each multi-value (256-value) data. This LUT indicates a correspondence relationship among a gradation value of color gradation value data (KCMY), a gradation value of white gradation value data, and a gradation value of RCT gradation value data with respect to the printing RGB data 1102. It is a feature of the present embodiment to adjust the gradation value of the white gradation value data in particular by the viewing condition (ratio of reflected light illuminance and transmitted light illuminance). Note that details of this LUT will be described later.

In quantization processing (S504), each data generated in S503 is quantized (binarized) by, for example, error diffusion. This generates binary KCMY data 1106 having a resolution of 1200 dpi, binary W data 1107, and binary RCT data 1108.

In distribution processing (S505), each data generated in S504 is distributed to a plurality of scans performed with respect to the predetermined region of the print head 9. This generates KCMY print data 1109, W print data 1110, and RCT print data 1111. The KCMY print data 1109 is data represented by 1-bit, 2-value information (0, 1) determining ejection or non-ejection of each ink of K, C, M, and Y with respect to each pixel in each of the plurality of scans with respect to the predetermined region of the printing medium P. The W print data 1110 is data represented by 1-bit, 2-value information (0, 1) determining ejection or non-ejection of the W ink with respect to each pixel in each of the plurality of scans with respect to the predetermined region of the printing medium P. The RCT print data 1111 is data represented by 1-bit, 2-value information (0, 1) determining ejection or non-ejection of the RCT ink with respect to each pixel in each of the plurality of scans with respect to the predetermined region of the printing medium P. This distribution processing (S505) is executed using a mask pattern that corresponds to the plurality of scans and determines permission or non-permission of ink ejection for each pixel.

Description of Adjustment of White Hiding Ratio in Accordance with Viewing Conditions

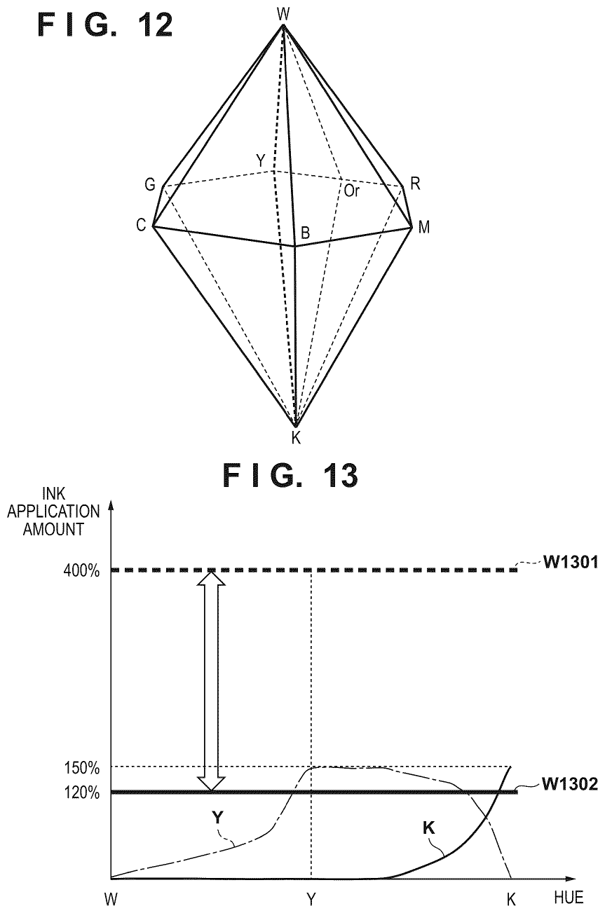

FIG. 12 is a schematic diagram illustrating a color reproduction region as a color solid. In this color solid, each point of R, Or, Y, G, C, B, and M is the maximum color saturation point in each hue of R, Or, Y, G, C, B, and M centered around a gray line from a white point W to a black point K. For the purpose of simplifying the description, adjustment of the white hiding ratio in the “W-Y-K hue line” connecting the white point W, a maximum color saturation point Y, and the black point K will be described below. However, the white hiding ratio is similarly adjusted in a W-M-K hue line and a W-C-K hue line.

FIG. 13 is a view describing application amount adjustment of ink in the W-Y-K hue line in accordance with the viewing condition (ratio of reflected light illuminance and transmitted light illuminance). In a case where the viewing condition is mainly the reflected light illuminance, the color image has higher color development as the white hiding ratio is higher, whereas in a case where the viewing condition is mainly the transmitted light, the color image has higher color development as the white hiding ratio is lower.

In view of this, in the color conversion processing (S503), the W ink application amount in the case where the viewing condition is mainly the reflected light illuminance (transmitted light illuminance ratio 0%) is set to be uniformly high as W1301. That is, whatever printing RGB data 1102 is input from the white point W through the maximum color saturation point Y to the black point K, the W ink application amount is set to be uniformly high.

On the other hand, the W ink application amount in a case where the viewing condition is mainly the transmitted light (transmitted light illuminance ratio 100%) is uniformly lowered as W1302. In practice, the W ink application amount is adjusted within the range of W1301 and W1302 in accordance with the value of the transmitted light illuminance ratio, which is a viewing condition input value actually input by the user. Note that here, W1301 is the W ink application amount of 400% at which the white hiding ratio becomes 80%, and W1302 is the W ink application amount of 120% at which the white hiding ratio becomes 60%.

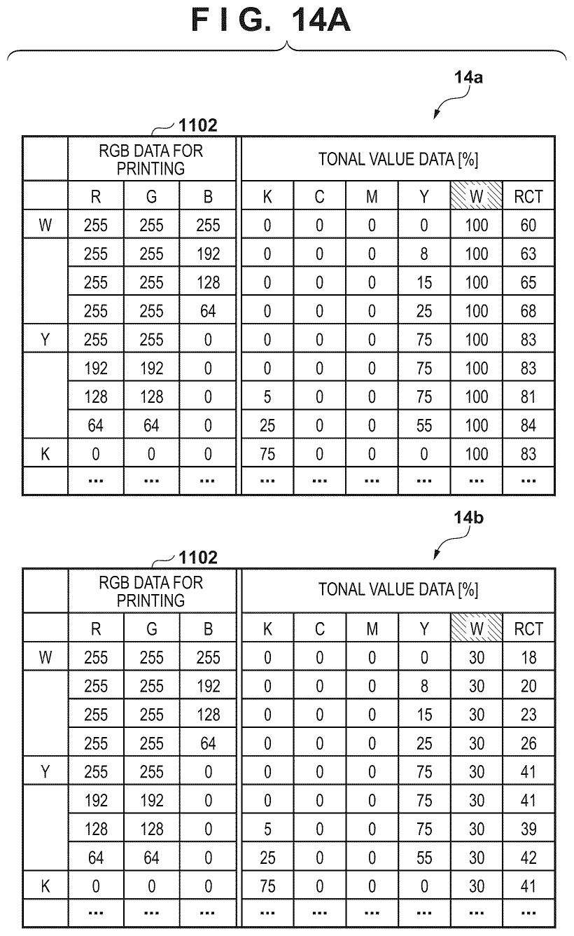

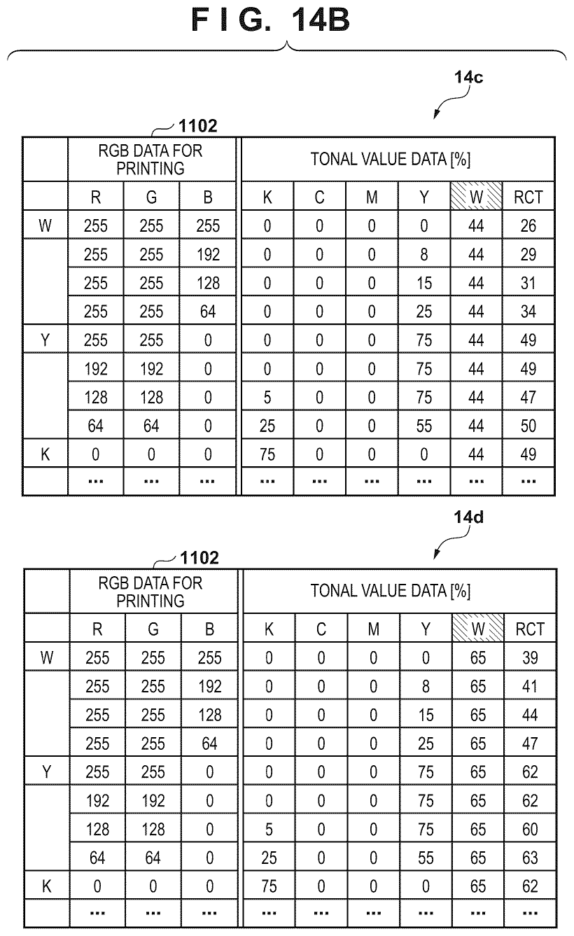

FIGS. 14A and 14B are views illustrating an example of the LUT used for determining the W ink application amount in accordance with the viewing condition (ratio of reflected light illuminance and transmitted light illuminance). In a case where the viewing condition is the transmitted light illuminance ratio of 0%, in accordance with an LUT 14a, whatever printing RGB data 1102 is input, the W gradation value data becomes 100% in the color conversion processing (S503). As described later, since the application amount of the W ink becomes 4 times in the distribution processing (S505), this is the W gradation value data corresponding to the final W ink application amount of 400%. In a case where the viewing condition is the transmitted light illuminance ratio of 100%, in accordance with an LUT 14b, whatever printing RGB data 1102 is input, the W gradation value data becomes 30% in the color conversion processing (S503). As described later, since the application amount of the W ink becomes 4 times in the distribution processing (S505), this is the W gradation value data corresponding to the final W ink application amount of 120%.

With respect to the print product 1000 illustrated in FIG. 10, the viewing condition corresponds to a case where the transmitted light illuminance ratio is 80%. Therefore, in accordance with an LUT 14c, whatever printing RGB data 1102 is input, the W gradation value data is 44% (=100%+(30%−100%)×80/100) in the color conversion processing (S503). This is the W gradation value data corresponding to the W ink application amount of 176% (=44%×4).

With respect to the print product 1001 illustrated in FIG. 10, the viewing condition corresponds to a case where the transmitted light illuminance ratio is 50%. Therefore, in accordance with the LUT 14c, whatever printing RGB data 1102 is input, the W gradation value data is 65% (=(100%+30%)×50/100) in the color conversion processing (S503). This is the W gradation value data corresponding to the W ink application amount of 260% (=65%×4).

Note that the ink application amount 100% mentioned in the present embodiment is defined as an amount in which one dot of the ejection amount 6 pL is arranged in one pixel of a predetermined region (e.g., 1/1200 inch square). As described later, the gradation value data of K, C, M, and Y, which are color inks, is a value ½ times the final W ink application amount because the application amount of the color ink is doubled in the distribution processing (S505). The gradation value data of the RCT ink has the same value as the final RCT ink application amount because the application amount of the RCT ink becomes equal in the distribution processing (S505).

### Print Control

In the present embodiment, in twelve scans with respect to a predetermined region on the printing medium P, the white image is first printed in the first six passes, that is, the first to sixth scans, and stack image printing of the color image is then performed in the second six passes, that is, the seventh to twelfth scans. The RCT ink forms an image in the first to twelfth scans.

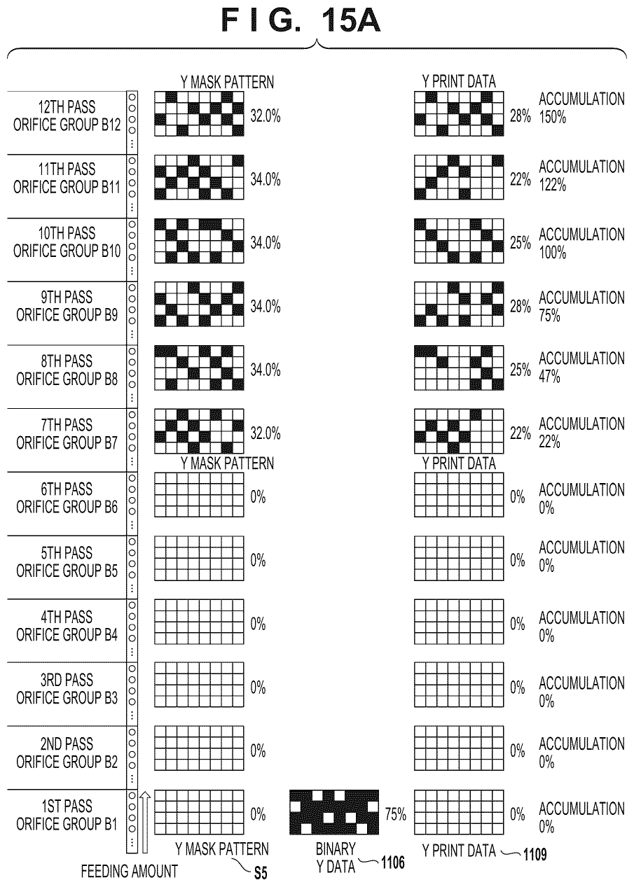

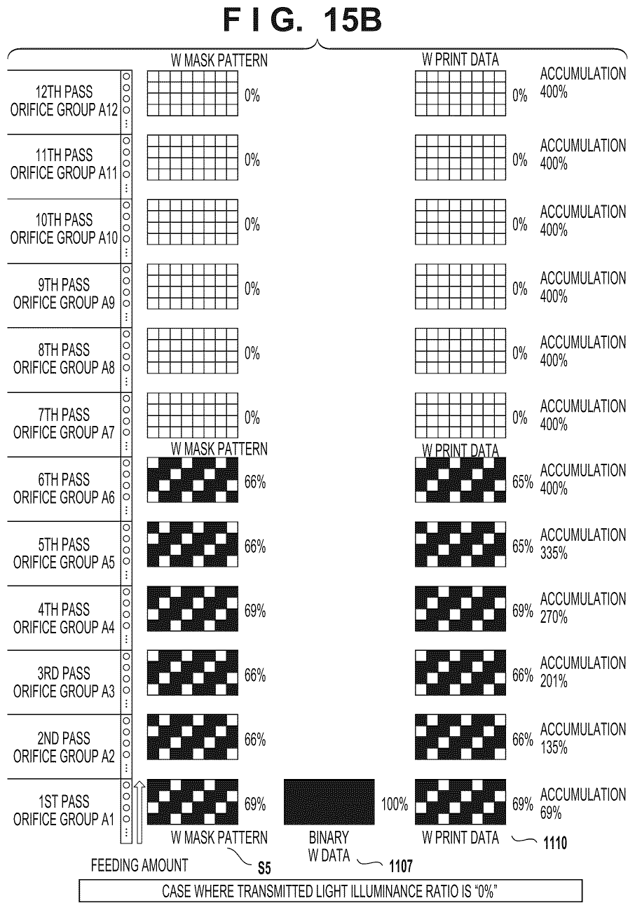

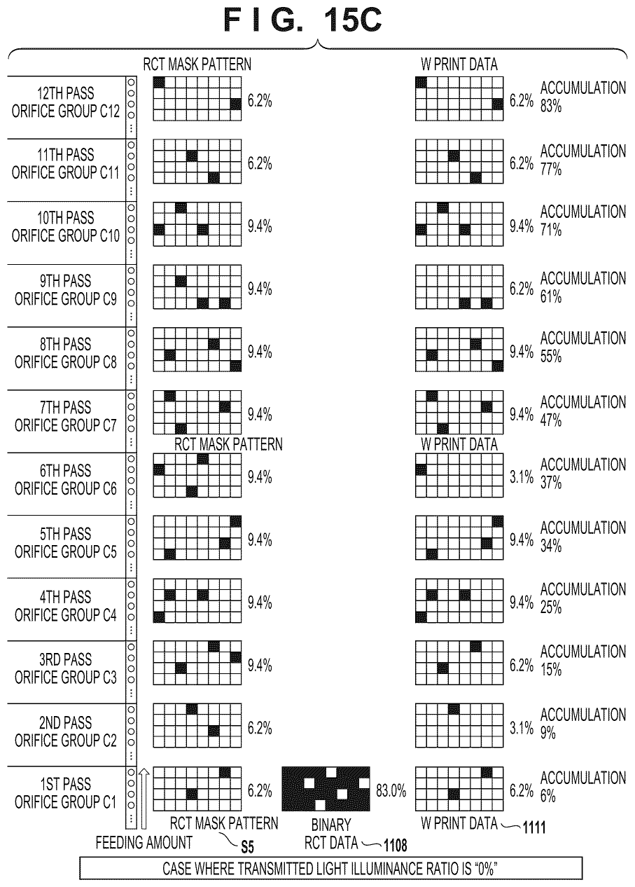

FIGS. 15A-15C are schematic diagrams illustrating an adjustment image of the W ink application amount in accordance with the distribution processing of the color ink, the W ink, and the reaction liquid ink and the presence or absence of the window use selection information.

Note that FIGS. 15A-15C illustrate mask pattern groups to be applied to quantized binary data corresponding to each of the ejection orifice row 30Y of the Y ink, the ejection orifice row 30W of the W ink, and the ejection orifice row 30RCT of the RCT ink. Note that FIG. 15A illustrates a mask pattern to be applied to the binary Y data of the Y ink as a mask pattern to be applied to the binary data of the color ink, but the mask pattern to be applied to the binary data of the K, C, and M inks is similarly set.

Here, in the mask pattern corresponding to the Y ink illustrated in FIG. 15A, twelve ejection orifice groups configured by dividing the ejection orifice row 30Y into twelve in the Y direction (conveyance direction) are defined as the ejection orifice groups B1 to B12. A print permission pixel is not arranged in each of the ejection orifice groups B1 to B6 used when the Y ink is ejected in each of the first to sixth scans with respect to a predetermined region. On the other hand, a print permission pixel is arranged in each of the ejection orifice groups B7 to B12 used when the Y ink is ejected in each of the seventh to twelfth scans with respect to the predetermined region. The total print permission rate of the mask pattern is assumed to be 200%.

As the binary Y data corresponding to the Y ink, a case of inputting binary Y data that determines ink ejection with respect to pixels of 75 (=24/32×100)%, for example, will be considered. In that case, the Y print data 1109 corresponding to the seventh to twelfth scans generated using a Y mask pattern illustrated in FIG. 15A determines ink ejection with respect to pixels of a total of 150% (=75%×2). That is, the application amount of the Y ink can be doubled before and after the distribution processing.

In the mask pattern corresponding to the W ink illustrated in FIG. 15B, twelve ejection orifice groups configured by dividing the ejection orifice row 30W into twelve in the Y direction (conveyance direction) are defined as the ejection orifice groups A1 to A12. A print permission pixel is arranged in each of the ejection orifice groups A1 to A6 used when the W ink is ejected in each of the first to sixth scans with respect to the predetermined region. On the other hand, a print permission pixel is not arranged in each of the ejection orifice groups A7 to A12 used when the W ink is ejected in each of the seventh to twelfth scans with respect to the predetermined region. The total print permission rate of the mask pattern is assumed to be 400%.

As the binary W data 1107 corresponding to the W ink, a case of inputting binary W data that determines ink ejection with respect to pixels of 100 (=32/32×100)%, for example, will be considered. In that case, the W print data 1110 corresponding to the first to sixth scans generated using a W mask pattern illustrated in FIG. 15B determines ink ejection with respect to pixels of a total of 400% (=100%×400/100). That is, the application amount of the W ink can be quadrupled before and after the distribution processing.

In the mask pattern corresponding to the RCT ink illustrated in FIG. 15C, twelve ejection orifice groups configured by dividing the ejection orifice row 30RCT into twelve in the Y direction (conveyance direction) are defined as the ejection orifice groups C1 to C12. A print permission pixel is arranged in each of the ejection orifice groups C1 to C12 used when the RCT ink is ejected in each of the first to twelfth scans with respect to the predetermined region. Here, the total print permission rate of the mask pattern is assumed to be 100%.

As the binary RCT data 1108 corresponding to the RCT ink, a case of inputting binary RCT data that determines ink ejection with respect to pixels of 83% (=27/32×100)%, for example, will be considered. In that case, the RCT print data 1111 corresponding to the first to twelfth scans generated using an RCT mask pattern illustrated in FIG. 15C determines ink ejection with respect to pixels of a total of 83%. That is, the application amount of the RCT ink becomes equal before and after the distribution processing.

Note that in the present embodiment, as in FIG. 13, the W ink application amount in a case where the viewing condition is the transmitted light illuminance ratio of 100% is uniformly lowered as W1302, but the present disclosure is not limited to this. The W ink application amount may be slightly increased or decreased in a range where fluctuation of the W hiding ratio is not noticeable along the W-Y-K hue line, for example.

As described above, according to the first embodiment, designation of the viewing condition (ratio of reflected light illuminance and transmitted light illuminance) is accepted when multipass stack image printing is performed. Then, the white ink application amount (white hiding ratio) of the white ink layer to be stacked on the color ink layer is adjusted based on the viewing condition. This can output a print product in which a decrease in color development depending on the viewing condition is suppressed.

### Second Embodiment

In the first embodiment described above, in the color conversion processing (S503), the W ink application amount in the case where the viewing condition is mainly the reflected light illuminance (transmitted light illuminance ratio 0%) remains uniformly high as W1301. In the second embodiment, an adjustment method of reducing the W ink application amount with respect to a color dark part for a case where the viewing condition is mainly the reflected light illuminance, that is, the transmitted light illuminance ratio is 0% will be described. Note that the color dark part refers to a part where the brightness is less than a predetermined brightness in a color image, and a color bright part refers to a part where the brightness is the predetermined brightness or more in the color image.

Regarding the color dark part, it has been found that even in a case where the viewing condition is mainly the reflected light illuminance, the color development is less likely to decrease even if the white hiding ratio is lowered. For example, as in the color reproduction region W-Y-K from the bright part to the dark part of the Y hue shown in the graph 9a, the color development of the color dark part does not change in both the color reproduction region (bold line 91) in a case where the white hiding ratio is high and the color reproduction region (dotted line 92) in a case where the white hiding ratio is low. With respect to the color dark part, it is suggested that the W ink application amount may be lowered even in a case where the viewing condition is mainly the reflected light illuminance.

Adjustment of White Hiding Ratio in Accordance with Viewing Conditions

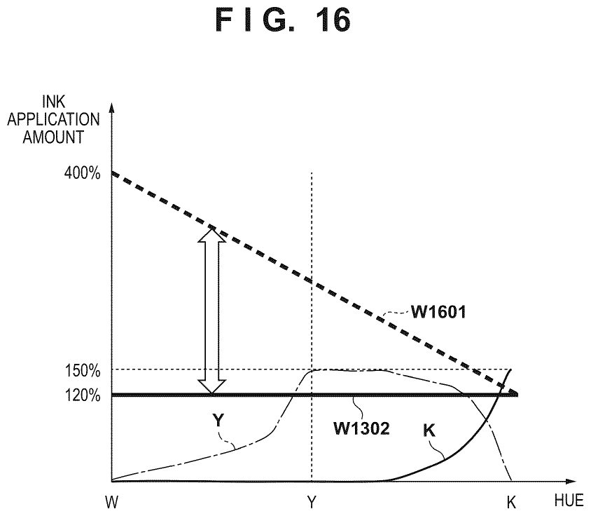

FIG. 16 is a view describing application amount adjustment of ink in the W-Y-K hue line in accordance with the viewing condition (ratio of reflected light illuminance and transmitted light illuminance) in the second embodiment. In a case where the viewing condition is mainly the reflected light illuminance, the color image has higher color development as the white hiding ratio is higher in the color bright part, whereas the color image has higher color development even if the white hiding ratio is low in the color dark part. In view of this, the W ink application amount in a case where the viewing condition is mainly the reflected light illuminance (transmitted light illuminance ratio of 0%) has a white hiding ratio gradually decreased from the white point W through the maximum color saturation point Y to the black point K as W1601. That is, the W ink application amount is 400% at the white point W, and the W ink application amount is 120% at the black point K. The white hiding ratio is lowered with respect to the color dark part.

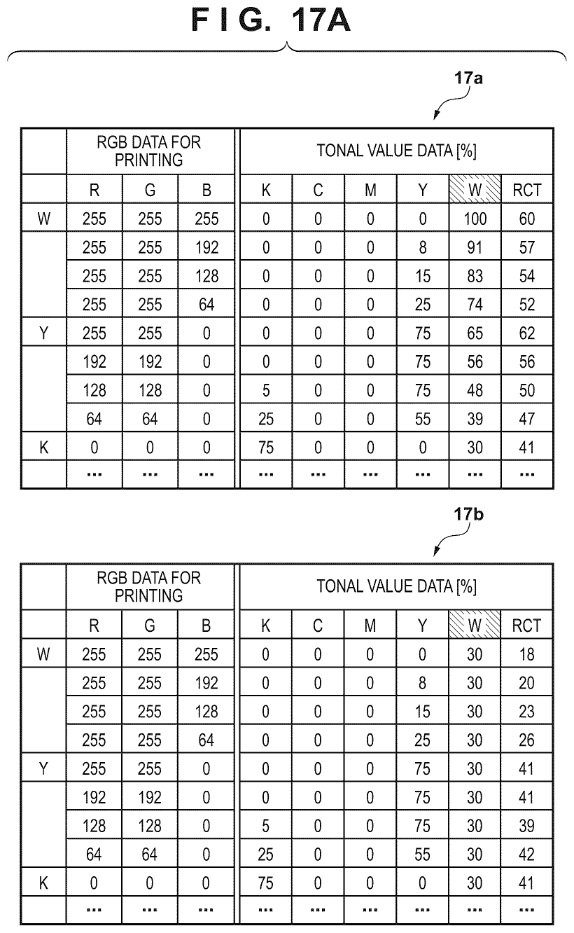

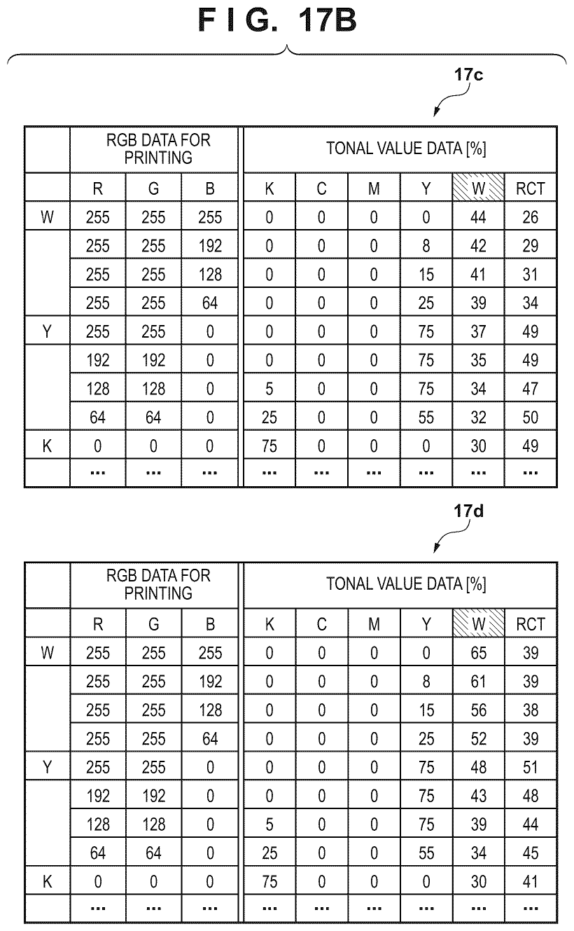

FIGS. 17A and 17B are views illustrating an example of the LUT used for determining the W ink application amount in accordance with the viewing condition (ratio of reflected light illuminance and transmitted light illuminance) in the second embodiment. When the viewing condition is the transmitted light illuminance ratio of 0%, adjustment is performed in accordance with an LUT 17a. Specifically, the W gradation value data is gradually lowered from the W gradation value data of 100% (i.e., the W ink application amount 400%) at the white point W to the W gradation value data of 65% (i.e., the W ink application amount 260%) at a Y maximum color saturation point. Thereafter, the W gradation value data at the black point K is lowered to 30% (i.e., the W ink application amount of 120%). An LUT 17b is the same as the LUT 14b in the first embodiment.

With respect to the print product 1000 illustrated in FIG. 10, since the viewing condition is the transmitted light illuminance ratio of 80%, adjustment is performed in accordance with an LUT 17c. Specifically, the W gradation value data is gradually lowered from the W gradation value data of 44% (i.e., the W ink application amount 176%) at the white point W to the W gradation value data of 37% (i.e., the W ink application amount 148%) at the Y maximum color saturation point. Thereafter, the W gradation value data at the black point K is lowered to 30% (i.e., the W ink application amount of 120%).

With respect to the print product 1001 illustrated in FIG. 10, since the viewing condition is the transmitted light illuminance ratio of 50%, adjustment is performed in accordance with an LUT 17d. Specifically, the W gradation value data is gradually lowered from the W gradation value data of 65% (i.e., the W ink application amount 260%) at the white point W to the W gradation value data of 48% (i.e., the W ink application amount 192%) at the Y maximum color saturation point. Thereafter, the W gradation value data at the black point K is lowered to 30% (i.e., the W ink application amount of 120%).

Note that in W1601 of FIG. 16, the W ink application amount at the black point K in a case of the transmitted light illuminance ratio of 0% is lowered to 120% (same as the W ink application amount at the black point K in the case of the transmitted light illuminance ratio of 100%). However, the W ink application amount may be less than 400%, and preferably less than 200%.

In W1601 of FIG. 16, the W ink application amount at the Y maximum color saturation point in the case of the transmitted light illuminance ratio of 0% was set to 260% (=(400%+120%)/2). That is, it is an arithmetic average value of the W ink application amounts at the white point W and the black point K in the case of the transmitted light illuminance ratio of 0%. However, the W ink application amount may be 400%. That is, in the W-Y-K hue line, at the color bright part (from the white point W to the Y maximum color saturation point), the W ink application amount of the case of the transmitted light illuminance ratio of 0% may be kept as high as 400%. Then, at the color dark part (from the Y maximum color saturation point to the black point K), the W ink application amount of the case of the transmitted light illuminance ratio of 0% may be configured to be gradually lowered from 400% to 120%.

### Details of Ink

Details of each ink constituting an ink set used in the present example will be described. Hereinafter, “part” and “%” are based on mass unless otherwise specified.

### 1. Black Ink

### (1-1) Preparation of Black Dispersion Liquid

First, an anionic polymer P-1 [styrene/butyl acrylate/acrylic acid copolymer (polymerization ratio (weight ratio)=30/40/30) acid value 202, weight average molecular weight 6500] was prepared. This was neutralized with an aqueous potassium hydroxide solution and diluted with ion-exchanged water to prepare a homogeneous 10 mass % polymer solution.

600 g of the polymer solution described above, 100 g of carbon black, and 300 g of ion-exchanged water are mixed and mechanically stirred for a predetermined time, and then a non-dispersed matter containing coarse particles is removed by centrifugation treatment to obtain a black dispersion liquid. The obtained black dispersion liquid had a pigment concentration of 10 mass %.

### (1-2) Preparation of Water-Soluble Resin Emulsion Dispersion Liquid

First, in a state of being heated to 70° C. under a nitrogen atmosphere, the following three additive liquids were added dropwise while being stirred by a motor, and polymerization was performed for 5 hours. The additive liquids are a hydrophobic monomer consisting of 28.5 parts of methyl methacrylate, a mixed liquid containing a hydrophilic monomer consisting of 4.3 parts of sodium p-styrenesulfonate and 30 parts of water, and a mixed liquid containing a polymerization initiator consisting of 0.05 parts of potassium persulfate and 30 parts of water. In this manner, a 20 mass % resin particle dispersion liquid was obtained. Note that the glass transfer temperature of the present resin fine particles is 60° C.

### (1-3) Preparation of Black Ink

In the preparation of the black ink, the black dispersion liquid described above is used and added with the following components to have a predetermined concentration. Then, these components were sufficiently mixed and stirred, and then were subjected to pressure filtration with a micro filter (manufactured by Fujifilm Corporation) having a pore size of 2.5 μm, and a pigment ink having a pigment concentration of 2 mass % was prepared.
Black dispersion liquid described above: 20 parts
Water-soluble resin emulsion dispersion liquid described above: 40 parts
Wax particles: 3 parts
Zonyl FSO-100 (fluorine surfactant manufactured by DuPont): 0.05 parts
1,2-butanediol: 15 parts
Acetylene glycol EO adduct (manufactured by Kawaken Fine Chemicals Co., Ltd.): 0.5 parts
Ion-exchanged water: balance

### 2. Yellow Ink

### (2-1) Preparation of Yellow Dispersion Liquid

First, the anionic polymer P-1 was neutralized with an aqueous potassium hydroxide solution and diluted with ion-exchanged water to prepare a homogeneous 10 mass % polymer solution.

300 g of the polymer solution described above, 100 g of C.I. Pigment Yellow 74, and 600 g of ion-exchanged water were mixed and mechanically stirred for a predetermined time, and then non-dispersed matter containing coarse particles was removed by centrifugation treatment to obtain a yellow dispersion liquid. The obtained yellow dispersion liquid had a pigment concentration of 10 mass %.

### (2-2) Preparation of Yellow Ink

In the preparation of the yellow ink, the yellow dispersion liquid described above was used, mixed with the following components, and sufficiently stirred to be dissolved and dispersed, and then subjected to pressure filtration with a micro filter (manufactured by Fujifilm Corporation) having a pore size of 1.0 μm, and a pigment ink having a pigment concentration of 4 mass % was prepared.
Yellow dispersion liquid described above: 40 parts
Water-soluble resin emulsion dispersion liquid described above: 40 parts
Wax particles: 3 parts
Zonyl FSO-100 (fluorine surfactant manufactured by DuPont) 0.025 parts
1,2-butanediol: 14 parts
1,2-hexanediol: 1 part
Acetylene glycol EO adduct (manufactured by Kawaken Fine Chemicals Co., Ltd.): 0.5 parts
Ion-exchanged water: balance

### 3. Reaction Liquid Ink

The reaction liquid ink used in the present example contains a reactant agent that reacts with a pigment contained in the ink and aggregates or gelatinizes the pigment. In the present example, a polyvalent metal salt was used as a reactant agent, and specifically, magnesium sulfate heptahydrate was used.

Note that it is not necessary to use magnesium sulfate heptahydrate, and in the present example, various organic acids and polyvalent metal salts can be used as a reactant agent of the reaction liquid as long as they are water-soluble. The content of the organic acid and the polyvalent metal salt is preferably 0.1 mass % or more and 90.0 mass % or less, and more preferably 1.0 mass % or more and 70.0 mass % or less, based on the total mass of the composition contained in the reaction liquid.

### (3-1) Preparation of Reaction Liquid Ink

In the present example, as mentioned earlier, magnesium sulfate heptahydrate was used, and the following components were mixed to prepare a reaction liquid ink.
Magnesium sulfate heptahydrate: 4 parts
1,2-butanediol: 10 parts
Acetylene glycol EO adduct: 0.5 parts
Ion-exchanged water: balance

### 4. White Ink

The composition of the white ink will be described. In the present embodiment, titanium oxide particles have particle surface coated with alumina and zirconia, and are used as a color material of the white ink. Titanium oxide has a rutile type, an anatase type, and a brookite type in terms of its crystal structure. Among them, titanium oxide is preferably the rutile type having low photocatalytic activity. Examples of a production method of titanium oxide include a sulfate method and a chlorine method. Examples of the rutile type titanium oxide whose particle surface is coated with alumina and zirconia include CR-97, UT771, PFC105, CR-57, CR-Super70, and PF-739 (manufactured by Ishihara Sangyo Kaisha, Ltd.), JR-603 (manufactured by Tayca Corporation), and GTR-100, R-38L, D-918, and D-970 (manufactured by Sakai Chemical Industry Co., Ltd.). The content (mass %) of titanium oxide particles in the first ink is preferably 5.0 mass % or more and 15.0 mass % or less based on the total mass of the ink.

The ζ potential of titanium oxide particles in pure water is preferably 0 mV or more. The ζ potential is an index indicating the charged state of the titanium oxide particle surface, and can be measured by the electrophoretic light scattering method. When the titanium oxide particle surface is less likely to be negatively charged, that is, the positive charge amount is larger than the negative charge amount on the titanium oxide particle surface, the titanium oxide particles are less likely to repel a color material dispersed due to the action of the anionic group, and therefore the color developability of the image is improved. By making the ζ potential of the titanium oxide particles to 0 mV or more, the positive charge amount becomes larger than the negative charge amount on the titanium oxide particle surface, and the color developability of the image is improved. The ζ potential is preferably 40 mV or less.

As a color material of the white ink, in addition to titanium oxide particles, resin particles having a hollow structure can be used in combination. Examples of the resin particles having a hollow structure include resin particles containing units derived from styrene and acrylic such as MH5055 (manufactured by Zeon Corporation), ROPAQUE OP-62, OP-84J, OP-91, HP-1055, HP-91, and ULTRA (manufactured by Rohm and Haas); and resin particles containing units derived from crosslinked styrene and acrylic such as SX-863(A), 864(B), 866(A), 866(B), and 868 (manufactured by JSR Corporation), ROPAQUE ULTRA E and ULTRA DUAL (manufactured by Rohm and Haas). The proportion (%) of titanium oxide particles in the color material in the white ink is preferably 30% or more, more preferably 65% or more, and still more preferably 100%.

### (4-1) Preparation of White Dispersion Liquid

First, an anionic polymer P-1 [styrene/butyl acrylate/acrylic acid copolymer (polymerization ratio (weight ratio)=30/40/30) acid value 202, weight average molecular weight 6500] was prepared. This was neutralized with an aqueous potassium hydroxide solution and diluted with ion-exchanged water to prepare a homogeneous 10 mass % aqueous polymer solution.

150 g of the polymer solution described above, 500 g of titanium oxide, and 350 g of ion-exchanged water were mixed, and the titanium oxide was dispersed using a homogenizer. Thereafter, non-dispersed matter containing coarse particles was removed by centrifugation treatment, an appropriate amount of ion-exchanged water was added, and a white dispersion liquid was obtained. The obtained white dispersion liquid had a pigment concentration of 30 mass %.

### (4-2) Preparation of White Ink

In the preparation of the white ink, the white dispersion liquid described above was used, mixed with the following components, and sufficiently stirred to be dissolved and dispersed, and then subjected to pressure filtration with a micro filter (manufactured by Fujifilm Corporation) having a pore size of 2.5 μm, and a pigment ink having a pigment concentration of 4 mass % was prepared.
White dispersion liquid: 40 parts
Water-soluble resin emulsion dispersion liquid described above: 40 parts
Zonyl FSO-100 (fluorine surfactant manufactured by DuPont) 0.025 parts
2-methyl 1,3 propanediol: 15 parts
2-pyrrolidone: 5 parts
Acetylene glycol EO adduct (manufactured by Kawaken Fine Chemicals Co., Ltd.): 1 part
Ion-exchanged water (manufactured by Kawaken Fine Chemicals Co., Ltd.): balance

### Printing Medium

As the printing medium P having a low absorbency, GIY-0305, which is a ultra PET substrate film (strong adhesion type) for window decoration manufactured by Lintec Corporation, was used.

### Color Development Evaluation of Color Image of Print Product

The print product was attached on an actual transparent glass window under various viewing conditions, and the color development of the color image was visually evaluated. At this time, the release paper of a transparent PET film (strong adhesion type) GIY-0305 was peeled off and applied with water, and then evaluated. The evaluation results are shown in Table 1.

PRINTING EXAMPLE 1: In a case where the environmental condition was the transmitted light illuminance ratio of 80%, the W ink application amount of the white image to be stacked onto the color image was set to 176% (=W gradation data 44%×4) as shown in the LUT 14c.

PRINTING EXAMPLE 2: In a case where the environmental condition was the transmitted light illuminance ratio of 80%, the W ink application amount of the white image to be stacked onto the color image was set to 176% (=W gradation data 44%×4) to 120% (=W gradation data 30%×4) from the white point W to the black point K as shown in the LUT 17c.

PRINTING EXAMPLE 3: In a case where the environmental condition was the transmitted light illuminance ratio of 50%, the W ink application amount of the white image to be stacked onto the color image was set to 260% (=W gradation data 65%×4) as shown in the LUT 14d.

PRINTING EXAMPLE 4: In a case where the environmental condition was the transmitted light illuminance ratio of 80%, the W ink application amount of the white image to be stacked onto the color image was set to 260% (=W gradation data 65%×4) to 120% (=W gradation data 30%×4) from the white point W to the black point K as shown in the LUT 17d.

COMPARATIVE EXAMPLE 1: In a case where the environmental condition was the transmitted light illuminance ratio of 80%, the W ink application amount of the white image to be stacked onto the color image was set to 400% (=W gradation data 100%×4) as in the LUT 14a.

COMPARATIVE EXAMPLE 2: In a case where the environmental condition was the transmitted light illuminance ratio of 80%, the W ink application amount of the white image to be stacked onto the color image was set to 120% (=W gradation data 30%×4) as in the LUT 14b. This is the optimum W ink application amount when the transmitted light illuminance ratio is 100%.

COMPARATIVE EXAMPLE 3: In a case where the environmental condition was the transmitted light illuminance ratio of 80%, the W ink application amount of the white image to be stacked onto the color image was set to 176% (=W gradation data 44%×4) to 0% from the white point W to the black point K.

COMPARATIVE EXAMPLE 4: In a case where the environmental condition was the transmitted light illuminance ratio of 80%, the W ink application amount of the white image to be stacked onto the color image was set to 176% (=W gradation data 44%×4) to 80% from the white point W to the black point K. This 80% is a value smaller than the optimum W ink application amount of 120% when the transmitted light illuminance ratio is 100%.

COMPARATIVE EXAMPLE 5: In a case where the environmental condition was the transmitted light illuminance ratio of 50%, the W ink application amount of the white image to be stacked onto the color image was set to 400% (=W gradation data 100%×4) as in the LUT 14a.

COMPARATIVE EXAMPLE 6: In a case where the environmental condition was the transmitted light illuminance ratio of 50%, the W ink application amount of the white image to be stacked onto the color image was set to 120% (=W gradation data 30%×4) as in the LUT 14b. This is the optimum W ink application amount when the transmitted light illuminance ratio is 100%.

COMPARATIVE EXAMPLE 7: In a case where the environmental condition was the transmitted light illuminance ratio of 50%, the W ink application amount of the white image to be stacked onto the color image was set to 176% (=W gradation data 44%×4) to 80% from the white point W to the black point K. This 80% is a value smaller than the optimum W ink application amount of 120% when the transmitted light illuminance ratio is 100%.

TABLE 1

| | | TRANSMITTED | | |
|---|---|---|---|---|
| | W INK APPLICATION | LIGHT | | W INK |
| | AMOUNT TO BE STACKED | ILLUMINANCE | COLOR | CONSUMPTION |
| | (BRIGHT PART-DARK PART) | RATIO | DEVELOPMENT | AMOUNT |
| PRINTING | 176%-176% | 80% | Excellent | Good |
| EXAMPLE 1 | | | | |
| PRINTING | 176%-120% | 80% | Excellent | Excellent |
| EXAMPLE 2 | | | | |
| PRINTING | 260%-260% | 50% | Excellent | Good |
| EXAMPLE 3 | | | | |
| PRINTING | 260%-120% | 50% | Excellent | Excellent |
| EXAMPLE 4 | | | | |
| COMPARATIVE | 400%-400% | 80% | Good | Poor |
| EXAMPLE 1 | | | | |
| COMPARATIVE | 120%-120% | 80% | Poor | Excellent |
| EXAMPLE 2 | | | | |
| COMPARATIVE | 176%-0% | 80% | Poor | Excellent |
| EXAMPLE 3 | | | | |
| COMPARATIVE | 176%-80% | 80% | Poor | Excellent |
| EXAMPLE 4 | | | | |
| COMPARATIVE | 400%-400% | 50% | Good | Poor |
| EXAMPLE 5 | | | | |
| COMPARATIVE | 120%-120% | 50% | Poor | Excellent |
| EXAMPLE 6 | | | | |
| COMPARATIVE | 260%-80% | 50% | Good | Excellent |
| EXAMPLE 7 | | | | |

In Printing Example 1, in a case of the transmitted light illuminance ratio of 80%, the W ink application amount to be stacked on the color image was reduced to be smaller than the W ink application amount of 400% at the time of the transmitted light illuminance ratio of 0%. By this, it is considered that transmitted light easily entered also from the back of a print product and contributed to the color development of a color image.

In Printing Example 2, particularly in the color dark part, color development was good even if the W ink application amount to be further stacked was reduced and the W ink application amount was reduced to 120% at the time of the transmitted light illuminance ratio of 100%. This is considered to be because even if the W hiding ratio of the color dark part is somewhat low, ambient illumination light from the observer side hardly escapes to the back, and the influence of reflected light on color development is small.

In contrast, in Comparative Example 1, in a case of the transmitted light illuminance ratio of 80%, the W ink application amount to be stacked on the color image is made equal to the W ink application amount of 400% at the time of the transmitted light illuminance ratio of 0%. By this, it is considered that transmitted light hardly entered also from the back of a print product and the color development of a color image was reduced. In Comparative Example 2, in a case of the transmitted light illuminance ratio of 80%, the W ink application amount to be stacked on the color image is made equal to the W ink application amount of 120% at the time of the transmitted light illuminance ratio of 100%. By this, it is considered that reflected light of 20% easily escaped to the back and the color development was reduced. In Comparative Examples 3 and 4, the W ink application amount in the color dark part is made less than 120%. By this, it is considered that reflected light of 20% easily escaped to the back and the color development in a color dark part was reduced.

In Printing Example 3, in a case of the transmitted light illuminance ratio of 50%, the W ink application amount to be stacked on the color image has been reduced to be smaller than the W ink application amount of 400% at the time of the transmitted light illuminance ratio of 0%. By this, it is considered that transmitted light easily entered also from the back of a print product and contributed to the color development of a color image.

In Printing Example 4, particularly in the color dark part, color development was good even if the W ink application amount to be further stacked was reduced and the W ink application amount was reduced to 120% at the time of the transmitted light illuminance ratio of 100%. This is considered to be because even if the W hiding ratio of the color dark part is somewhat low, ambient illumination light from the observer side hardly escapes to the back, and the influence of reflected light on color development is small.

In contrast, in Comparative Example 5, in a case of the transmitted light illuminance ratio of 50%, the W ink application amount to be stacked on the color image is made equal to the W ink application amount of 400% at the time of the transmitted light illuminance ratio of 0%. By this, it is considered that transmitted light hardly entered also from the back of a print product and the color development of a color image was reduced. In Comparative Example 6, in a case of the transmitted light illuminance ratio of 50%, the W ink application amount to be stacked on the color image is made equal to the W ink application amount of 120% at the time of the transmitted light illuminance ratio of 100%. By this, it is considered that reflected light of 50% easily escaped to the back and the color development was reduced. In Comparative Example 7, the W ink application amount in the color dark part is made less than 120%. By this, it is considered that reflected light of 50% easily escaped to the back and the color development in a color dark part was reduced.

As described above, according to the second embodiment, in addition to adjustment of the W ink application amount in the first embodiment, the W ink application amount is reduced with respect to the color dark part in a case of the transmitted light illuminance ratio of 0%. This can output a print product in which a decrease in color development depending on the viewing condition is suppressed.

### OTHER EMBODIMENTS

In the first and second embodiments, a form in which a similar adjustment is performed with respect to an arbitrary hue (i.e., adjustment independent of hue) in adjustment of the W ink application amount has been described. However, the adjustment method (FIG. 13 or 16) of the white hiding ratio in accordance with the viewing condition may be changed in accordance with the hue.

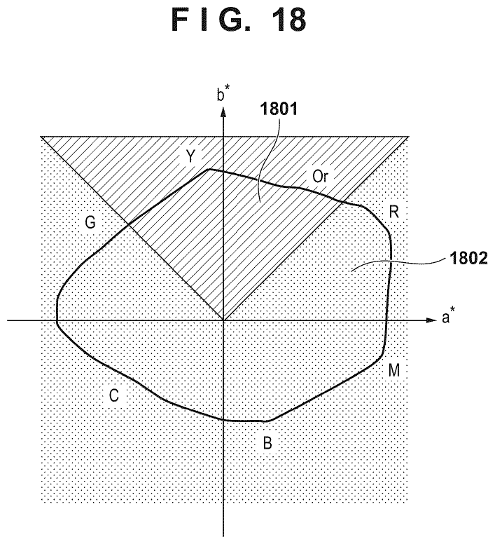

FIG. 18 is a view illustrating a color reproduction region in which the adjustment method of the white hiding ratio is varied in accordance with the hue angle. In a color reproduction region 1801 (range of hue lines of Or, Y, and G) of the color reproduction region, the W ink application amount in a case where the viewing condition is mainly the reflected light illuminance (transmitted light illuminance ratio 0%) is uniformly kept high as W1301. On the other hand, in a color reproduction region 1802 (range of hue lines of C, B, M, and R), the W ink application amount in a case where the viewing condition is the transmitted light illuminance ratio of 0% may be lowered from the bright part to the dark part as in W1601.

In general, among color inks, the Y ink tends to have color development closer to the bright part (L* is higher) (compared with K, C and M inks). Therefore, in the color reproduction region 1801 of a primary color and a secondary color using the Y ink, the W ink application amount in a case of the transmitted light illuminance ratio of 0% is preferably kept uniformly high as in W1301. However, the adjustment method of the white hiding ratio at the transmitted light illuminance ratio of 0% in accordance with the hue angle is not limited to FIG. 18. For example, the hue range of the color reproduction region 1801 may be configured to be widened (e.g., to include up to a C hue). Conversely, the hue range of the color reproduction region 1801 may be configured to be narrowed (e.g., not to include a G hue).

The input image data 1100 of FIG. 11 may be accepted via a UI screen displayed on a monitor of the host PC 412 as the acquisition processing (S502) of window use selection information.

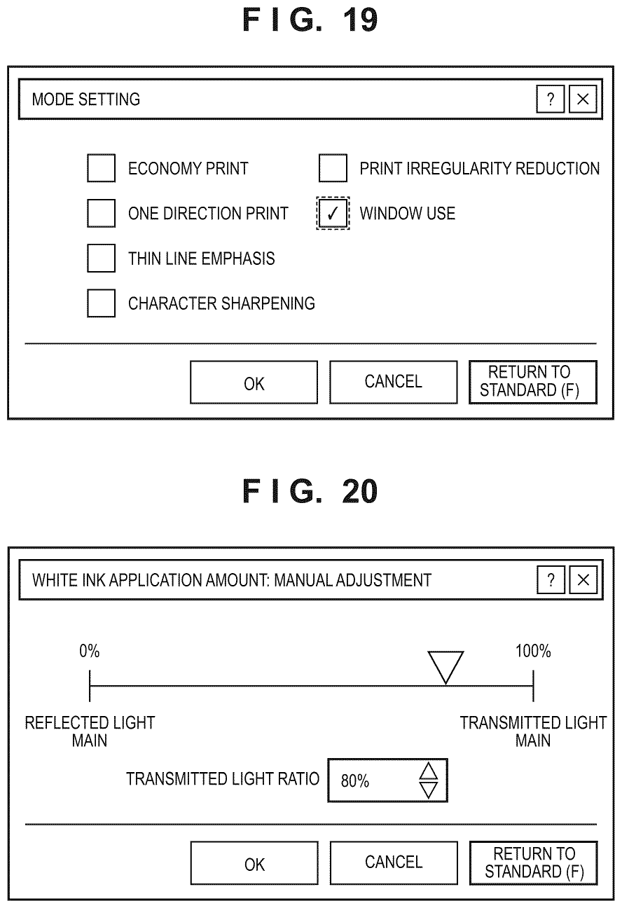

FIG. 19 is a view illustrating an example of a UI screen that accepts printing mode selection of “window use”. In a case where the user checks a check box of this “window use”, the LUT is switched in the color conversion processing (S503). That is, the LUT to be referred to is switched from that having the transmitted light illuminance ratio of 0% such as the LUT 14a and the LUT 17a to that such as the LUTs 14b, 14c, and 14d in accordance with the value of the transmitted light illuminance ratio, which is a viewing condition. On the other hand, in a case where the check box of “window use” is not checked, the LUT to be referred to is one having the transmitted light illuminance ratio of 0% such as the LUT 14a and the LUT 17a.

Furthermore, along with the UI screen as in FIG. 19, a UI screen on which the user can manually adjust the white ink application amount depending on the “reflected light illuminance/transmitted light illuminance” ratio may be provided.

FIG. 20 is a view illustrating an example of a UI screen on which the white ink application amount can be manually adjusted. In accordance with the value of the transmitted light illuminance ratio input via such a UI screen, an optimum lookup table for the transmitted light illuminance ratio is selected from among the lookup tables referred to in the color conversion processing (S503) of FIG. 11.

Note that here, the UI screen to be displayed on the monitor of the host PC 412 is used, but the present disclosure is not limited to this, and, for example, an operation unit prepared in the printing apparatus 100 may be used. The viewing condition (ratio of reflected light illuminance and transmitted light illuminance) may be weighted by the irradiation angle of the reflected light or the transmitted light.

While a form in which the reaction liquid ink in each embodiment does not contain a color material at all has been described, it may contain some color material within a range that does not affect image quality. Note that in the present embodiment, a case of slightly containing a color material within a range that does not affect image quality is also included in the expression of “not containing a color material”.

In each embodiment, the inkjet printing apparatus and the printing method using the inkjet printing apparatus have been described, but the present disclosure can also be applied to an image processing apparatus or an image processing method for generating data for performing the printing method described in each embodiment. The present disclosure can also be applied to a form in which a program for performing the printing method described in each embodiment is prepared separately from the printing apparatus.

The present embodiment can be effectively applied to various image printing apparatuses such as what is called a piezo type inkjet printing apparatus that ejects ink using a piezoelectric element, for example, in addition to a thermal jet type inkjet printing apparatus.

Note that in each of the embodiments described above, a serial type inkjet printer has been described as an example, but the present disclosure is not limited to this, and a printer may have a print head including a line head in which colors are arranged along a sheet conveyance direction.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

What is claimed is:

1. An inkjet printing apparatus comprising:
a first printing unit that prints a specific color image by applying a specific color ink having a specific color on a printing medium;
a second printing unit that prints a color image by applying a color ink onto the specific color image printed on the printing medium; and
a control unit that controls an application amount of the specific color ink by the first printing unit,
wherein the control unit determines an application amount per unit area of the specific color ink in accordance with a viewing condition in a case where an observer views a printing medium on which the color image is printed.

2. The inkjet printing apparatus according to claim 1, wherein the viewing condition is based on a first illuminance, which is reflected light of light by a first illumination existing on a side closer to the observer than the printing medium when the observer views the color image printed on the printing medium, and a second illuminance, which is transmitted light of light by a second illumination existing on a side opposite to the observer with respect to the printing medium when the observer views the color image printed on the printing medium.

3. The inkjet printing apparatus according to claim 2, wherein the control unit makes an application amount per unit area of the specific color ink in a case where the viewing condition indicates that a relative ratio of the second illuminance to a sum of the first illuminance and the second illuminance is lower than a first ratio larger than an application amount per unit area of the specific color ink in a case where the relative ratio is indicated to be higher than the first ratio.

4. The inkjet printing apparatus according to claim 3, wherein, in a case when the relative ratio is indicated to be lower than the first ratio, the control unit makes an applied ejection amount per unit area of the specific color ink with respect to a region where brightness is less than a predetermined brightness in the color image smaller than an application amount per unit area of the specific color ink with respect to a region where brightness is equal to or more than the predetermined brightness in the color image.

5. The inkjet printing apparatus according to claim 3, wherein the color ink contains a black (K) ink, a cyan (C) ink, a magenta (M) ink, and a yellow (Y) ink, and
the control unit makes an application amount per unit area of the specific color ink with respect to a region where brightness is less than a predetermined brightness in the color image larger than an application amount per unit area of the specific color ink with respect to a region where brightness is equal to or more than the predetermined brightness in the color image when the relative ratio is indicated to be lower than the first ratio with respect to a hue range using the Y ink, and
makes an application amount per unit area of the specific color ink with respect to a region where brightness is less than a predetermined brightness in the color image smaller than an application amount per unit area of the specific color ink with respect to a region where brightness is equal to or more than the predetermined brightness in the color image when the relative ratio is indicated to be lower than the first ratio with respect to a hue range not using the Y ink.

6. The inkjet printing apparatus according to claim 2, wherein the control unit makes an applied ejection amount per unit area of the specific color ink in a case where the viewing condition indicates that a relative ratio of the second illuminance to a sum of the first illuminance and the second illuminance is higher than a second ratio smaller than an application amount per unit area of the specific color ink in a case where the relative ratio is indicated to be lower than the second ratio.

7. The inkjet printing apparatus according to claim 1, wherein the control unit varies an application amount per unit area of the specific color ink in accordance with a hue.

8. The inkjet printing apparatus according to claim 1, wherein the printing medium is transparent to at least part of visible light.

9. The inkjet printing apparatus according to claim 1, wherein the specific color ink is a white ink.

10. The inkjet printing apparatus according to claim 1, wherein an acceptance unit that accepts the viewing condition from a user.

11. A control method of an inkjet printing apparatus, wherein the inkjet printing apparatus includes a first printing unit that prints a specific color image by applying a specific color ink having a specific color on a printing medium, a second printing unit that prints a color image by applying a color ink onto the specific color image printed on the printing medium, and a control unit that controls an application amount of the specific color ink by the first printing unit, and the control method includes:
accepting a viewing condition in a case where an observer views a printing medium on which the color image is printed; and
determining an application amount per unit area of the specific color ink in accordance with the viewing condition.

12. An image processing apparatus comprising:
a control unit that controls a first printing of printing a specific color image applying a specific color ink having a specific color on a printing medium and a second printing of printing a color image by applying a color ink on the specific color image printed on the printing medium, wherein
the control unit determines an application amount per unit area of the specific color ink in accordance with a viewing condition in a case where an observer views a printing medium on which the color image is printed.

13. A non-transitory computer-readable recording medium storing a program that, when executed by a computer, causes the computer to perform a control method of an inkjet printing apparatus, wherein the inkjet printing apparatus includes a first printing unit that prints a specific color image by applying a specific color ink having a specific color on a printing medium, a second printing unit that prints a color image by applying a color ink onto the specific color image printed on the printing medium, and a control unit that controls an application amount of the specific color ink by the first printing unit, and the control method includes:
accepting a viewing condition in a case where an observer views a printing medium on which the color image is printed; and
determining an application amount per unit area of the specific color ink in accordance with the viewing condition.
